(19) United States
(12) Patent Application Publication
(10) Pub. No.: US 2026/0252849 A1
(43) Pub. Date: Aug. 27, 2026

(54) SYSTEM

(71) Applicant: SoftBank Group Corp., Tokyo (JP)

(72) Inventor: Koji NOMURA, Tokyo (JP)

(73) Assignee: SoftBank Group Corp., Tokyo (JP)

(21) Appl. No.: 19/539,231

(22) Filed: Feb. 13, 2026

(30) Foreign Application Priority Data
Feb. 21, 2025 (JP) 2025-027026

(51) Int. Cl. G06N 3/045

(52) U.S. Cl. CPC G06N 3/045

(57) ABSTRACT

The system according to the embodiment comprises a learning unit, a creation unit, a test unit, and an analysis unit. The learning unit learns data related to a market. The creation unit creates a pseudo persona based on features learned by the learning unit. The test unit conducts reaction tests using the pseudo persona created by the creation unit. The analysis unit analyzes test results obtained by the test unit.

### CROSS-REFERENCE TO RELATED APPLICATION

The present application claims priority to and incorporates by reference the entire contents of Japanese Patent Application No. 2025-027026 filed in Japan on Feb. 21, 2025.

### BACKGROUND OF THE INVENTION

### 1. Field of the Invention

The technology of this disclosure relates to a system.

### 2. Description of the Related Art

Japanese Patent Application Laid-open No. 2022-180282 discloses a persona chatbot control method executed by at least one processor, comprising: receiving a user utterance, adding the user utterance to a prompt containing instructions related to the character of the chatbot, encoding the prompt, inputting the encoded prompt into a language model, and generating a chatbot utterance in response to the user utterance.

In conventional technology, there has been a problem that it is difficult to accurately predict reactions to one's own products when launching new products or entering new markets.

### SUMMARY OF THE INVENTION

The system according to the embodiment comprises a learning unit, a creation unit, a test unit, and an analysis unit. The learning unit learns data related to a market. The creation unit creates a pseudo persona based on features learned by the learning unit. The test unit conducts reaction tests using the pseudo persona created by the creation unit. The analysis unit analyzes test results obtained by the test unit.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a conceptual diagram showing an example configuration of a data processing system according to the first embodiment;

FIG. 2 is a conceptual diagram showing an example of main functions of a data processing device and a smart device according to the first embodiment;

FIG. 3 is a conceptual diagram showing an example configuration of a data processing system according to the second embodiment;

FIG. 4 is a conceptual diagram showing an example of main functions of a data processing device and smart glasses according to the second embodiment;

FIG. 5 is a conceptual diagram showing an example configuration of a data processing system according to the third embodiment;

FIG. 6 is a conceptual diagram showing an example of main functions of a data processing device and a headset-type terminal according to the third embodiment;

FIG. 7 is a conceptual diagram showing an example configuration of a data processing system according to the fourth embodiment;

FIG. 8 is a conceptual diagram showing an example of main functions of a data processing device and a robot according to the fourth embodiment;

FIG. 9 shows an emotion map where multiple emotions are mapped; and

FIG. 10 shows an emotion map where multiple emotions are mapped.

### DETAILED DESCRIPTION OF THE PREFERRED EMBODIMENTS

Hereinafter, an example of an embodiment of the system related to the technology disclosed herein will be described with reference to the attached drawings.

First, the terminology used in the following description will be explained.

In the following embodiments, a processor denoted by a reference numeral (hereinafter simply referred to as “processor”) may be a single computing device or a combination of multiple computing devices. The processor may be a single type of computing device or a combination of multiple types of computing devices. Examples of computing devices include a CPU (Central Processing Unit), GPU (Graphics Processing Unit), GPGPU (General-Purpose computing on Graphics Processing Units), APU (Accelerated Processing Unit), or TPU (Tensor Processing Unit), among others.

In the following embodiments, a RAM (Random Access Memory) denoted by a reference numeral is a memory where information is temporarily stored and used as a work memory by the processor.

In the following embodiments, a storage denoted by a reference numeral is one or more non-volatile storage devices for storing various programs and parameters. Examples of non-volatile storage devices include flash memory (SSD (Solid State Drive)), magnetic disks (e.g., hard disks), or magnetic tapes, among others.

In the following embodiments, a communication I/F (Interface) denoted by a reference numeral is an interface including a communication processor and an antenna, among others. The communication I/F manages communication between multiple computers. Examples of communication standards applicable to the communication I/F include wireless communication standards such as 5G (5th Generation Mobile Communication System), Wi-Fi (registered trademark), or Bluetooth (registered trademark), among others.

In the following embodiments, “A and/or B” means “at least one of A and B.” In other words, “A and/or B” means it may be only A, only B, or a combination of A and B. Moreover, when expressing three or more items connected by “and/or,” the same concept as “A and/or B” applies.

### First Embodiment

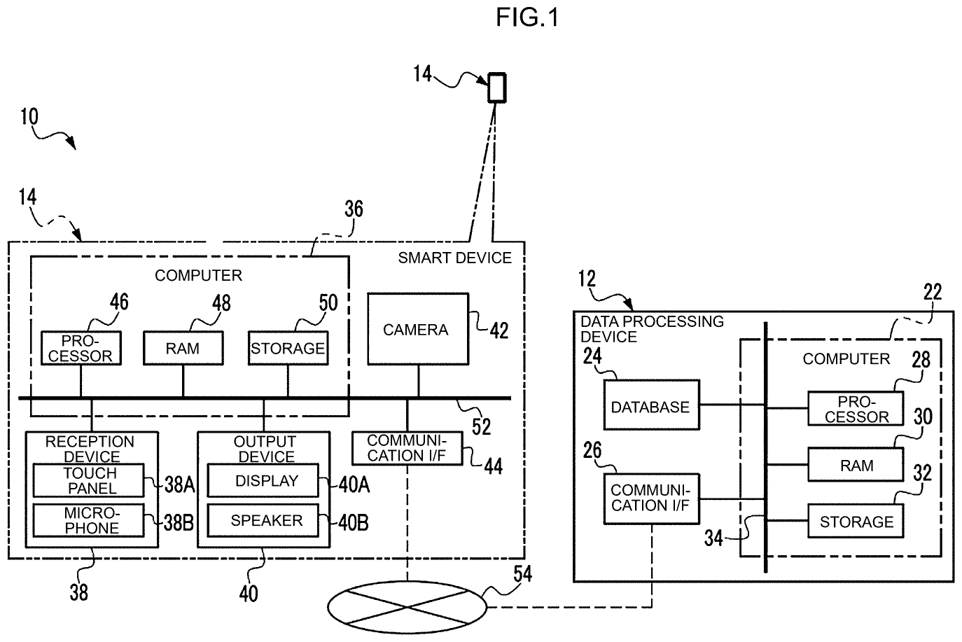

FIG. 1 shows an example configuration of a data processing system 10 according to the first embodiment.

As shown in FIG. 1, the data processing system 10 comprises a data processing device 12 and a smart device 14. An example of the data processing device 12 is a server.

The data processing device 12 comprises a computer 22, a database 24, and a communication I/F 26. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN (Wide Area Network) and/or a LAN (Local Area Network), among others.

The smart device 14 comprises a computer 36, a reception device 38, an output device 40, a camera 42, and a communication I/F 44. The computer 36 comprises a processor 46, RAM 48, and storage 50. The processor 46, RAM 48, and storage 50 are connected to a bus 52. The reception device 38, output device 40, and camera 42 are also connected to the bus 52.

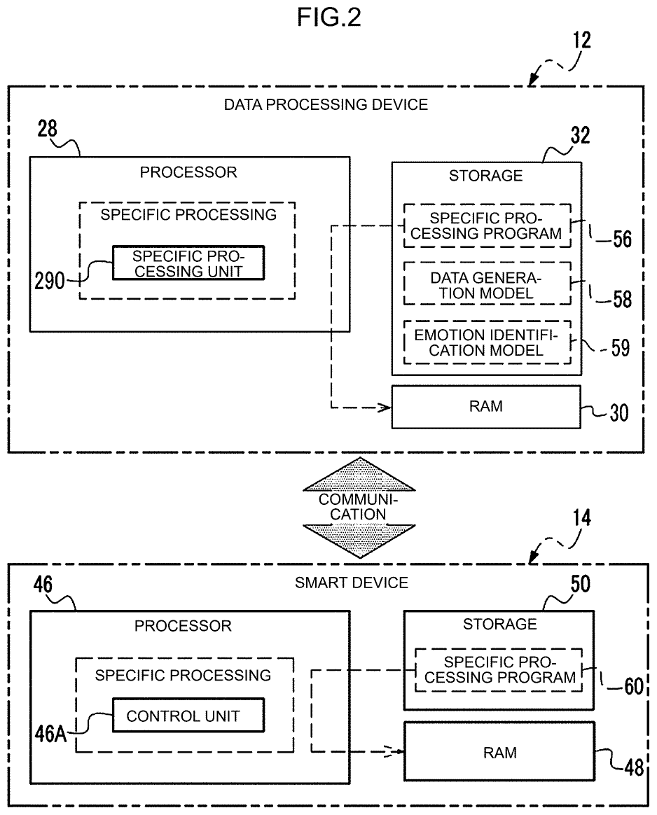

The reception device 38 comprises a touch panel 38A and a microphone 38B, among others, and accepts user input. The touch panel 38A accepts user input by detecting contact from an indicating object (e.g., a pen or finger). The microphone 38B accepts user input by detecting the user's voice. The control unit 46A sends data indicating user input accepted by the touch panel 38A and microphone 38B to the data processing device 12. The data processing device 12 has a specific processing unit 290 (see FIG. 2) that acquires data indicating user input.

The output device 40 comprises a display 40A and a speaker 40B, among others, and presents data to the user by outputting it in a perceptible form (e.g., audio and/or text). The display 40A displays visible information such as text and images according to instructions from the processor 46. The speaker 40B outputs audio according to instructions from the processor 46. The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors.

The communication I/F 44 is connected to the network 54. The communication I/F 44 and 26 manage the exchange of various information between the processor 46 and the processor 28 via the network 54.

FIG. 2 shows an example of the main functions of the data processing device 12 and the smart device 14.

As shown in FIG. 2, specific processing is performed in the data processing device 12 by the processor 28. The storage 32 stores a specific processing program 56. The specific processing program 56 is an example of a “program” related to the technology disclosed herein. The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, but is not limited to such examples. Furthermore, emotion estimation and prediction may include, for example, emotion analysis.

In the smart device 14, specific processing is performed by the processor 46. The storage 50 stores a specific processing program 60. The specific processing program 60 is used in conjunction with the specific processing program 56 by the data processing system 10. The processor 46 reads the specific processing program 60 from the storage 50 and executes it on the RAM 48. The specific processing is realized by the processor 46 operating as a control unit 46A according to the specific processing program 60 executed on the RAM 48. The smart device 14 may also have similar data generation models and emotion identification models as the data generation model 58 and emotion identification model 59, and perform the same processing as the specific processing unit 290 using these models.

Other devices besides the data processing device 12 may have the data generation model 58. For example, a server device (e.g., a generation server) may have the data generation model 58. In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.). Next, an example of processing by the data processing system 10 according to the first embodiment will be described.

### Example of the Embodiment

The market reaction prediction system according to the embodiment of the present invention is a system for understanding reactions to one's own products when launching new products or entering new markets. This market reaction prediction system can create a pseudo persona closely resembling individuals existing in the market using generative AI, and conduct reaction tests using the pseudo persona. First, data related to the market is input to the generative AI, and the generative AI learns features of individuals existing in the market based on the data. Next, a pseudo persona is created based on the features learned by the generative AI. This pseudo persona possesses features very close to those of actual individuals in the market, and by conducting reaction tests, it is possible to predict the market's reaction to one's own products. For example, by introducing a new product to the pseudo persona and observing its reaction, it is possible to predict the actual market reaction. This service enables reduction of risks associated with launching new products or entering new markets, and allows for the formulation of more effective marketing strategies. For instance, it is important to provide a learning unit for inputting data related to the market to the generative AI and having the generative AI learn features of individuals existing in the market based on the data, a creation unit for creating a pseudo persona based on the features learned by the generative AI, a test unit for conducting reaction tests using the pseudo persona, and an analysis unit for analyzing test results and formulating marketing strategies. As a result, the market reaction prediction system can reduce risks associated with launching new products or entering new markets and formulate effective marketing strategies. Specifically, this market reaction prediction system, unlike conventional market research or questionnaire aggregation conducted by humans, utilizes high-dimensional data analysis and generative models by computers, enabling the handling of vast market data (e.g., millions of purchase histories, thousands of types of competitor product information, time-series economic indicator data, etc.) as vectorized and tensorized input data. The learning unit of this system, for example, uses multilayer perceptrons or Transformer-type neural networks and accepts as input consumer attribute vectors (e.g., age, gender, purchase history, region, preference score, etc. as 100-dimensional vectors), competitor trend tensors (e.g., time-series sales trends, price fluctuations, advertising volume, etc. as 50×12 tensors), and economic indicator arrays (e.g., GDP growth rate, unemployment rate, consumer confidence index, etc. as 20-dimensional arrays). Specific examples of input data include a vector such as “30-year-old female, purchased cosmetics 5 times in the past year, resides in Kanto, preference score 0.8,” and a time-series tensor such as “Competitor A's sales trend from January to December 2023.” The learning unit normalizes and encodes these, and extracts latent features in the feature extraction layer. The generative AI, based on the extracted features, uses generative models such as VAE (Variational Autoencoder) or diffusion models to output attribute vectors of pseudo personas approximating real consumers (e.g., age 35, male, purchase tendency: new product oriented, price sensitivity: high, SNS usage frequency: 5 times per week, etc.). Examples of output include “Pseudo Persona A: 40-year-old male, purchased home appliances 10 times in the past year, price sensitivity 0.7, high SNS posting frequency.” The test unit inputs new product information (e.g., product description text, images, price information, etc.) to the created pseudo persona, and the generative AI outputs the persona's reaction (e.g., purchase intention score 0.85, generation of positive comments, generation of negative feedback, etc.). Examples of output include “Purchase intention score 0.92” and “Comment: The design is good but the price is high.” The analysis unit aggregates these reaction data, performs statistical analysis (e.g., clustering, principal component analysis, regression analysis, etc.) and data mining (e.g., association analysis, anomaly detection, etc.), and outputs decision support information for marketing strategy formulation (e.g., reaction distribution by target group, price optimization proposals, recommended advertising channels, etc.). These series of processes are executed at high speed on parallel computing clusters using GPUs, achieving significant improvements in processing speed and accuracy compared to conventional manual research, aggregation, and analysis. Furthermore, by applying advanced technologies such as weight optimization, loss function minimization, data augmentation, and transfer learning at each stage of AI model learning, generation, testing, and analysis, the generalization performance and adaptability of the model can be enhanced. As a technical effect, this system can predict reactions of diverse consumer profiles with high accuracy and speed before market launch, enabling scientific optimization of decision-making for product development and marketing strategies. In addition, the application fields include new product development for consumer goods manufacturers, new market entry for service industries, campaign design for advertising agencies, risk assessment for financial institutions when introducing new services, and can be utilized in a wide range of industries and business types.

The market reaction prediction system according to the embodiment comprises a learning unit, a creation unit, a test unit, and an analysis unit. The learning unit learns data related to a market. The data related to a market may include, for example, consumer purchase history, competitor trends, economic indicators, but is not limited thereto. The learning unit learns market data using algorithms such as machine learning or deep learning, for example. The generative AI learns features of individuals existing in the market based on large amounts of market data. The creation unit creates a pseudo persona based on features learned by the generative AI. The pseudo persona may be created based on, for example, target customer profiles or behavioral patterns, but is not limited thereto. The creation unit uses generative AI to create a pseudo persona with features very close to those of actual individuals existing in the market. The test unit conducts reaction tests using the pseudo persona. Reaction tests may include, for example, questionnaire surveys or A/B tests, but are not limited thereto. The test unit uses generative AI to observe the reactions of the pseudo persona and collect data. The analysis unit analyzes test results obtained by the test unit. The analysis may include, for example, statistical analysis or data mining, but is not limited thereto. The analysis unit uses generative AI to provide information for formulating marketing strategies based on test results. As a result, the market reaction prediction system according to the embodiment can reduce risks associated with launching new products or entering new markets and formulate effective marketing strategies. Specifically, this market reaction prediction system accepts various market data such as consumer attribute vectors (e.g., age, gender, purchase history, region, preference score, etc. as 100-dimensional vectors), competitor trend tensors (e.g., time-series sales trends, price fluctuations, advertising volume, etc. as 50×12 tensors), and economic indicator arrays (e.g., GDP growth rate, unemployment rate, consumer confidence index, etc. as 20-dimensional arrays) in the learning unit. The learning unit normalizes and encodes these data and performs feature extraction using, for example, multilayer perceptrons or Transformer-type neural networks. Examples of input include vectors such as “30-year-old female, purchased cosmetics 5 times in the past year, resides in Kanto, preference score 0.8,” and time-series tensors such as “Competitor A's sales trend from January to December 2023.” The generative AI, based on the extracted latent features, uses generative models such as VAE (Variational Autoencoder) or diffusion models to output attribute vectors of pseudo personas approximating real consumers (e.g., age 35, male, purchase tendency: new product oriented, price sensitivity: high, SNS usage frequency: 5 times per week, etc.). Examples of output include “Pseudo Persona A: 40-year-old male, purchased home appliances 10 times in the past year, price sensitivity 0.7, high SNS posting frequency.” The test unit inputs new product information (e.g., product description text, images, price information, etc.) to the created pseudo persona, and the generative AI outputs the persona's reaction (e.g., purchase intention score 0.85, generation of positive comments, generation of negative feedback, etc.). Examples of output include “Purchase intention score 0.92” and “Comment: The design is good but the price is high.” The analysis unit aggregates these reaction data, performs statistical analysis such as clustering, principal component analysis, regression analysis, and data mining such as association analysis and anomaly detection, and outputs decision support information such as reaction distribution by target group, price optimization proposals, and recommended advertising channels. These series of processes are executed at high speed on parallel computing clusters using GPUs, achieving significant improvements in processing speed and accuracy compared to conventional manual research, aggregation, and analysis. Furthermore, by applying advanced technologies such as weight optimization, loss function minimization, data augmentation, and transfer learning at each stage of AI model learning, generation, testing, and analysis, the generalization performance and adaptability of the model can be enhanced. As a technical effect, this system can predict reactions of diverse consumer profiles with high accuracy and speed before market launch, enabling scientific optimization of decision-making for product development and marketing strategies. In addition, the application fields include new product development for consumer goods manufacturers, new market entry for service industries, campaign design for advertising agencies, risk assessment for financial institutions when introducing new services, and can be utilized in a wide range of industries and business types.

The learning unit can input data related to a market and enable the generative AI to learn features of individuals existing in the market based on the data. The learning unit, for example, inputs market data such as consumer purchase history, competitor trends, and economic indicators, and the generative AI learns features of individuals existing in the market based on the data. The generative AI learns market data using algorithms such as machine learning or deep learning, for example. The generative AI extracts and learns features of individuals existing in the market based on large amounts of market data. Thus, the learning unit can learn features of individuals existing in the market based on data related to the market. Some or all of the above-described processing in the learning unit may be performed using generative AI or without using generative AI. For example, the learning unit may input market data to the generative AI, and the generative AI learns features of individuals existing in the market. Specifically, the learning unit accepts various market data as input, such as consumer attribute vectors (e.g., age, gender, purchase history, region, preference score, etc. as 100-dimensional vectors), competitor trend tensors (e.g., time-series sales trends, price fluctuations, advertising volume, etc. as 50×12 tensors), and economic indicator arrays (e.g., GDP growth rate, unemployment rate, consumer confidence index, etc. as 20-dimensional arrays). Examples of input include vectors such as “30-year-old female, purchased cosmetics 5 times in the past year, resides in Kanto, preference score 0.8,” and time-series tensors such as “Competitor A's sales trend from January to December 2023.” The learning unit normalizes and encodes these data and performs feature extraction using, for example, multilayer perceptrons or Transformer-type neural networks. The generative AI, based on the extracted latent features, uses generative models such as VAE (Variational Autoencoder) or diffusion models to learn feature vectors approximating real consumers. The learning unit uses loss functions such as cross-entropy or mean squared error and updates weights using algorithms such as gradient descent or Adam optimization. As a result, the learning unit can automate feature extraction and pattern recognition of high-dimensional, multivariate data, which was difficult with conventional simple aggregation or manual analysis, and greatly improve the generalization performance and adaptability of the model. As a technical effect, the learning unit is robust to the diversity and variability of market data and can respond quickly to real-time market changes, thereby greatly improving the accuracy and speed of product development and marketing strategies. Application fields include market analysis and demand forecasting for various industries such as consumer goods, service industries, advertising, and finance.

The creation unit can create a pseudo persona based on features learned by the generative AI. The creation unit, for example, creates a pseudo persona based on features learned by the generative AI. The pseudo persona may be created based on, for example, target customer profiles or behavioral patterns, but is not limited thereto. The creation unit uses generative AI to create a pseudo persona with features very close to those of actual individuals existing in the market. The generative AI learns features such as target customer age, gender, purchase history, and creates a pseudo persona based on those features. Thus, the creation unit can create a pseudo persona based on features learned by the generative AI. Some or all of the above-described processing in the creation unit may be performed using generative AI or without using generative AI. For example, the creation unit may create a pseudo persona based on features learned by the generative AI. Specifically, the creation unit accepts as input latent feature vectors extracted by the learning unit (e.g., age 35, male, purchase tendency: new product oriented, price sensitivity: high, SNS usage frequency: 5 times per week, etc.). Examples of input include “age 40, male, purchased home appliances 10 times in the past year, price sensitivity 0.7, high SNS posting frequency.” The creation unit uses generative models such as VAE (Variational Autoencoder) or diffusion models to generate attribute vectors of pseudo personas approximating real consumers from these features. Examples of output include “Pseudo Persona A: 40-year-old male, high frequency of home appliance purchases, price sensitivity 0.7, high SNS posting frequency.” In the generation process of the generative AI, the creation unit can apply latent space sampling or conditional generation to create diverse personas tailored to specific target groups or behavioral patterns. Furthermore, the creation unit utilizes weight optimization and data augmentation techniques of the generative AI to enhance the generalization performance and diversity of the model. As a technical effect, the creation unit can automatically generate high-dimensional, multivariate consumer profiles that were difficult to design with conventional simple attribute combinations or manual persona design, enabling more realistic and diverse market reaction simulations. Application fields include new product development, advertising targeting, service design, financial product design, and various other fields.

The test unit can conduct reaction tests using the pseudo persona. The test unit, for example, conducts reaction tests using the pseudo persona. Reaction tests may include, for example, questionnaire surveys or A/B tests, but are not limited thereto. The test unit uses generative AI to observe the reactions of the pseudo persona and collect data. The generative AI, for example, introduces a new product to the pseudo persona and observes its reaction. The generative AI predicts actual market reactions based on the reactions of the pseudo persona. Thus, the test unit can predict market reactions to one's own products by conducting reaction tests using the pseudo persona. Some or all of the above-described processing in the test unit may be performed using generative AI or without using generative AI. For example, the test unit may input the reactions of the pseudo persona to the generative AI, and the generative AI conducts reaction tests. Specifically, the test unit accepts as input the attribute vectors of pseudo personas generated by the creation unit (e.g., age 40, male, high frequency of home appliance purchases, price sensitivity 0.7, high SNS posting frequency) and new product information (e.g., product description text, images, price information, etc.). Examples of input include combinations such as “description text+image+price information of new product A” and “attribute vector of pseudo persona A.” The test unit uses generative AI (e.g., large language models or multimodal generative models) to output the persona's reaction (e.g., purchase intention score 0.85, generation of positive comments, generation of negative feedback, etc.). Examples of output include “Purchase intention score 0.92” and “Comment: The design is good but the price is high.” The test unit passes the output reaction data to subsequent processing such as threshold judgment or clustering, and detects reaction tendencies or anomalies for each target group. As a technical effect, the test unit can automate and accelerate reaction prediction for large-scale and diverse consumer profiles, which was difficult with conventional manual questionnaires or A/B tests, enabling scientific optimization of decision-making for product development and marketing strategies. Application fields include new product development, advertising effectiveness measurement, service design, financial product evaluation, and various other fields.

The analysis unit can analyze test results and provide information for formulating marketing strategies. The analysis unit, for example, analyzes test results obtained by the test unit. The analysis may include, for example, statistical analysis or data mining, but is not limited thereto. The analysis unit uses generative AI to provide information for formulating marketing strategies based on test results. The generative AI, for example, analyzes consumer reactions based on test results and provides information for formulating marketing strategies. Thus, the analysis unit can formulate more effective marketing strategies by analyzing test results and providing information for marketing strategy formulation. Some or all of the above-described processing in the analysis unit may be performed using generative AI or without using generative AI. For example, the analysis unit may input test results to the generative AI, and the generative AI analyzes the test results. Specifically, the analysis unit accepts as input reaction data output by the test unit (e.g., purchase intention score, positive comments, negative feedback, etc. as structured data). Examples of input include “Purchase intention score 0.92” and “Comment: The design is good but the price is high.” The analysis unit performs statistical analysis such as clustering, principal component analysis, regression analysis, and data mining such as association analysis and anomaly detection, and outputs decision support information such as reaction distribution by target group, price optimization proposals, and recommended advertising channels. Examples of output include “Average purchase intention score for target group A: 0.85” and “Price optimization proposal: recommend a 5% price reduction from the current price.” The analysis unit passes the output decision support information to dashboard display or report generation modules to support decision-making by management or marketing personnel. As a technical effect, the analysis unit can automate and accelerate pattern extraction and strategy proposals for high-dimensional, multivariate data, which was difficult with conventional simple aggregation or manual analysis, thereby greatly improving the accuracy and speed of marketing strategies. Application fields include new product development, advertising campaign design, service improvement, financial product strategy formulation, and various other fields.

The learning unit can estimate user emotions and adjust the timing of learning market data based on the estimated user emotions. The learning unit, for example, estimates user emotions and adjusts the timing of learning market data based on the estimated user emotions. User emotions are estimated using technologies such as emotion analysis or facial expression recognition, for example. The generative AI, for example, adjusts to quickly learn market data when the user is excited. The generative AI can also adjust to learn market data slowly when the user is relaxed. Furthermore, the generative AI can temporarily stop learning market data when the user feels stressed and wait until the user calms down. Thus, the learning unit can learn market data at more appropriate timing by adjusting the timing of learning market data based on user emotions. Emotion estimation is realized using emotion estimation functions with emotion engines or generative AI, for example. The generative AI may be a text generative AI (e.g., LLM) or a multimodal generative AI, but is not limited thereto. Some or all of the above-described processing in the learning unit may be performed using generative AI or without using generative AI. For example, the learning unit may input user emotion data to the generative AI, and the generative AI adjusts the timing of learning market data. Specifically, the learning unit accepts as input multimodal data for user emotion estimation, such as face image tensors (e.g., 224×224×3 RGB images), voice waveform data (e.g., 16,000-dimensional array for 1 second at 16 kHz sampling), and text utterance data (e.g., 100-token natural language sentences). Examples of input include “smiling face image,” “voice waveform of excited voice,” and “text such as ‘I'm excited about the new product.’” The learning unit extracts features from these multimodal data using CNN or Transformer-type neural networks and outputs emotion labels such as “excited,” “relaxed,” “stressed,” and emotion scores (e.g., excitement level 0.85, relaxation level 0.10, stress level 0.05) in the emotion classification layer. Examples of output include “Emotion label: excited, score 0.92” and “Emotion label: relaxed, score 0.75.” The learning unit dynamically adjusts hyperparameters such as learning start timing, batch size, number of epochs, and learning rate in the learning scheduler module based on these emotion estimation results. For example, when the excitement level is high, the batch size is increased and the learning frequency is raised. When the stress level is high, learning is temporarily stopped and resumed after a certain period. These controls enable adaptive learning control according to user state, unlike conventional fixed-schedule learning. As a technical effect, the learning unit can reduce the user's psychological burden and learn market data at optimal timing, thereby improving the efficiency and accuracy of model learning. In addition, the linkage of real-time emotion estimation and learning control can enhance the quality of user experience. Application fields include consumer research systems, educational AI assistants, patient monitoring in the medical field, and interactive advertising in the entertainment field, among others.

The learning unit can adjust the learning algorithm by referring to past market trends during learning of market data. The learning unit, for example, adjusts the learning algorithm by referring to past market trends. Past market trends may include, for example, past sales data or economic indicators, but are not limited thereto. The generative AI, for example, refers to market trend data from the past five years and optimizes the learning algorithm. The generative AI can also refer to market trend data related to specific seasons or events and adjust the learning algorithm. Furthermore, the generative AI can extract trends from past market trend data and improve the learning algorithm. Thus, the learning unit can optimize the learning algorithm by referring to past market trends, enabling more accurate learning of market data. Some or all of the above-described processing in the learning unit may be performed using generative AI or without using generative AI. For example, the learning unit may input past market trend data to the generative AI, and the generative AI adjusts the learning algorithm. Specifically, the learning unit accepts as input past market trend data such as time-series sales tensors (e.g., 60 months of sales data, 60×1 tensor), seasonal event flag arrays (e.g., event flags for 12 months, 12-dimensional binary array), and time-series economic indicators (e.g., GDP growth rate, unemployment rate, consumer confidence index, etc. as 60×3 tensors). Examples of input include “monthly sales data from 2019 to 2023,” “event flags for Christmas, New Year, summer vacation,” and “monthly GDP growth rate.” The learning unit extracts time-series features from these time-series data using LSTM or Transformer-type neural networks and calculates features such as moving averages, seasonal variation components, and event impact in the trend extraction layer. The learning unit automatically optimizes hyperparameters of the learning algorithm (e.g., learning rate, batch size, weight initialization method, regularization coefficient, etc.) based on these features. For example, the learning rate is increased in event months with rapid sales growth and decreased during stable periods for adaptive control. Furthermore, the learning unit can detect change points in past trends and dynamically change the model architecture (e.g., number of layers, number of hidden units). Examples of output include “learning rate changed from 0.01 to 0.05” and “batch size changed from 32 to 64.” These processes enable dynamic optimization based on past data, unlike conventional static learning algorithm settings. As a technical effect, the learning unit can achieve high-precision model learning reflecting market seasonality and event impacts, greatly improving prediction accuracy and adaptability. Application fields include demand forecasting in retail, advertising delivery optimization, risk assessment for financial products, supply chain management, and various other fields.

The learning unit can focus on a specific market segment during learning of market data. The learning unit, for example, focuses on a specific market segment during learning. Specific market segments may include, for example, youth market segments, senior market segments, or regional market segments, but are not limited thereto. The generative AI, for example, focuses on the youth market segment and learns the data. The generative AI can also focus on the senior market segment and learn the data. Furthermore, the generative AI can focus on regional market segments and learn the data. Thus, the learning unit can learn market data with a more targeted focus by focusing on a specific market segment. Some or all of the above-described processing in the learning unit may be performed using generative AI or without using generative AI. For example, the learning unit may input data of a specific market segment to the generative AI, and the generative AI learns the data. Specifically, the learning unit accepts as input segment attribute vectors (e.g., age group, gender, region, income class, preferences, etc. as 50-dimensional vectors), segment-specific purchase history tensors (e.g., monthly purchase counts for youth, regional sales trends, etc. as 10×12 tensors), and segment-specific reaction score arrays (e.g., interest scores for new products, etc. as 10-dimensional arrays). Examples of input include vectors such as “18-25 years old, female, urban area, middle income, fashion preference” and “purchase history of elderly in the Kanto region.” The learning unit extracts features from these segment data using Transformer-type neural networks or clustering algorithms and learns latent patterns and purchase tendencies for each segment. The learning unit sets different loss function weights and data sampling ratios for each segment to achieve model learning optimized for the target group. Examples of output include “purchase tendency of youth segment: new product oriented” and “price sensitivity of senior segment: high.” These processes enable individual optimization for each target group, unlike conventional overall average-type learning. As a technical effect, the learning unit can achieve high-precision market prediction and demand analysis specialized for specific segments, maximizing the effectiveness of marketing measures. Application fields include targeted advertising, regionally focused product development, age group-specific service design, personalized financial products, and various other fields.

The learning unit can estimate user emotions and determine the priority of learning data based on the estimated user emotions. The learning unit, for example, estimates user emotions and determines the priority of learning data based on the estimated user emotions. User emotions are estimated using technologies such as emotion analysis or facial expression recognition, for example. The generative AI, for example, prioritizes learning important market data when the user is excited. The generative AI can also prioritize learning detailed market data when the user is relaxed. Furthermore, the generative AI can prioritize learning simple market data when the user feels stressed. Thus, the learning unit can prioritize learning important market data by determining the priority of learning data based on user emotions. Emotion estimation is realized using emotion estimation functions with emotion engines or generative AI, for example. The generative AI may be a text generative AI (e.g., LLM) or a multimodal generative AI, but is not limited thereto. Some or all of the above-described processing in the learning unit may be performed using generative AI or without using generative AI. For example, the learning unit may input user emotion data to the generative AI, and the generative AI determines the priority of learning data. Specifically, the learning unit accepts as input multimodal data for user emotion estimation, such as face image tensors (e.g., 224×224×3), voice waveform data (e.g., 16,000 dimensions), and text utterance data (e.g., 100 tokens). Examples of input include “smiling face image” and “text such as ‘I am looking forward to the new product.’” The learning unit processes these data using CNN or Transformer-type neural networks and outputs emotion labels and scores (e.g., excitement level 0.9, relaxation level 0.7, stress level 0.2). The learning unit assigns priority scores to each data in the learning dataset based on emotion estimation results and performs batch learning in order of higher priority data. For example, when the excitement level is high, new product-related data or important market fluctuation data are prioritized for learning, and when the relaxation level is high, detailed attribute data or supplementary data are prioritized. When the stress level is high, simple data or basic data are prioritized. Examples of output include “Priority 1: new product data” and “Priority 2: detailed attribute data.” These processes enable dynamic data prioritization control according to user state, unlike conventional random sampling or fixed order learning. As a technical effect, the learning unit can select learning data optimized for user concentration and psychological state, thereby improving learning efficiency and model accuracy. Application fields include educational AI, personalized marketing, medical diagnostic support, interactive advertising, and various other fields.

The learning unit can consider geographical market characteristics during learning of market data. The learning unit, for example, considers geographical market characteristics during learning. Geographical market characteristics may include, for example, urban market characteristics, rural market characteristics, or international market characteristics, but are not limited thereto. The generative AI, for example, considers urban market characteristics and learns the data. The generative AI can also consider rural market characteristics and learn the data. Furthermore, the generative AI can consider international market characteristics and learn the data. Thus, the learning unit can learn market data more regionally specialized by considering geographical market characteristics. Some or all of the above-described processing in the learning unit may be performed using generative AI or without using generative AI. For example, the learning unit may input data of geographical market characteristics to the generative AI, and the generative AI learns the data. Specifically, the learning unit accepts as input regional attribute vectors (e.g., urban/rural/overseas flag, region code, population density, average income, etc. as 20-dimensional vectors), region-specific purchase history tensors (e.g., monthly sales data for urban, rural, and overseas, 3×12 tensors), and region-specific reaction score arrays (e.g., interest scores for new products by region, 3-dimensional arrays). Examples of input include “urban area: Tokyo, population 14 million, average income 6 million yen” and “rural area: Nagano Prefecture, population 200,000, average income 3.5 million yen.” The learning unit extracts features from these geographical data using Transformer-type neural networks or geospatial clustering algorithms and learns purchase tendencies and reaction patterns for each region. The learning unit sets different loss function weights and data sampling ratios for each region to achieve region-specialized model learning. Examples of output include “urban new product orientation: high,” “rural price sensitivity: high,” and “overseas market brand orientation: strong.” These processes enable individual optimization reflecting regional characteristics, unlike conventional nationwide uniform learning. As a technical effect, the learning unit can construct models that accurately reflect consumer behavior and market characteristics for each region, contributing to the optimization of regionally focused marketing and global expansion. Application fields include regional revitalization support, urban service development, overseas market entry strategies, tourism demand forecasting, and various other fields.

The learning unit can analyze social media trends and reflect them in learning during learning of market data. The learning unit, for example, analyzes social media trends and reflects them in learning. Social media trends may include, for example, popular hashtags, influencer posts, or user comments, but are not limited thereto. The generative AI, for example, analyzes popular hashtags on social media and learns the data. The generative AI can also analyze influencer posts on social media and learn the data. Furthermore, the generative AI can analyze user comments on social media and learn the data. Thus, the learning unit can learn more up-to-date market data by analyzing social media trends and reflecting them in learning. Some or all of the above-described processing in the learning unit may be performed using generative AI or without using generative AI. For example, the learning unit may input social media trend data to the generative AI, and the generative AI learns the data. Specifically, the learning unit accepts as input hashtag frequency vectors (e.g., occurrence counts of 1,000 types of hashtags, 1,000-dimensional vectors), influencer post tensors (e.g., number of posts by 100 people over 12 months, 100×12 tensors), and user comment embedding vectors (e.g., comment vectors encoded by BERT, 768 dimensions). Examples of input include hashtag frequencies such as “#newproduct” and “#buzzword,” “monthly post count of famous influencer A,” and user comments such as “This product is innovative.” The learning unit extracts features from these social media data using natural language processing models or graph neural networks and calculates trending words and topic scores in the trend detection layer. The learning unit preferentially incorporates data with high trend scores into the learning dataset and adapts model weights to the latest trends. Examples of output include “Trending hashtag: #newproduct, score 0.95” and “Trending influencer: A, influence score 0.88.” These processes enable real-time trend-reflective learning, unlike conventional static data learning. As a technical effect, the learning unit can immediately reflect the latest market trends and changes in consumer interest in the model, greatly improving prediction accuracy and responsiveness of marketing measures. Application fields include SNS marketing, brand monitoring, advertising effectiveness measurement, consumer behavior analysis, and various other fields.

The creation unit can estimate user emotions and adjust features of the pseudo persona based on the estimated user emotions. The creation unit, for example, estimates user emotions and adjusts features of the pseudo persona based on the estimated user emotions. User emotions are estimated using technologies such as emotion analysis or facial expression recognition, for example. The generative AI, for example, creates a pseudo persona with active features when the user is excited. The generative AI can also create a pseudo persona with calm features when the user is relaxed. Furthermore, the generative AI can create a pseudo persona with cool features when the user feels stressed. Thus, the creation unit can create a more appropriate pseudo persona by adjusting features of the pseudo persona based on user emotions. Emotion estimation is realized using emotion estimation functions with emotion engines or generative AI, for example. The generative AI may be a text generative AI (e.g., LLM) or a multimodal generative AI, but is not limited thereto. Some or all of the above-described processing in the creation unit may be performed using generative AI or without using generative AI. For example, the creation unit may input user emotion data to the generative AI, and the generative AI adjusts features of the pseudo persona. Specifically, the creation unit accepts as input multimodal data for user emotion estimation, such as face image tensors (e.g., 224×224×3 RGB images), voice waveform data (e.g., 16,000-dimensional array for 1 second at 16 kHz sampling), and text utterance data (e.g., 100-token natural language sentences). Examples of input include “smiling face image,” “text such as ‘I'm excited about the new product,’” and “voice waveform of excited voice.” The creation unit processes these data using CNN or Transformer-type neural networks and outputs emotion labels such as “excited,” “relaxed,” “stressed,” and emotion scores (e.g., excitement level 0.85, relaxation level 0.10, stress level 0.05) in the emotion classification layer. Examples of output include “Emotion label: excited, score 0.92” and “Emotion label: relaxed, score 0.75.” The creation unit adds emotion parameters to the latent feature vector as generation conditions for the generative AI and adjusts the attribute vector of the pseudo persona (e.g., activeness score, cooperativeness score, risk tolerance, etc.) using generative models such as VAE or diffusion models. For example, when the excitement level is high, the activeness score is set to 0.9; when the relaxation level is high, the cooperativeness score is set to 0.8; when the stress level is high, the coolness score is set to 0.95. Examples of output include “Pseudo Persona A: activeness 0.9, cooperativeness 0.6, coolness 0.2” and “Pseudo Persona B: activeness 0.3, cooperativeness 0.8, coolness 0.9.” The creation unit utilizes weight optimization and conditional generation techniques of the generative AI to realize diverse persona generation according to user emotions. These processes enable dynamic and automatic feature adjustment according to user state, unlike conventional fixed attribute settings or manual adjustments. As a technical effect, the creation unit can generate real-time personas reflecting user psychological states, greatly improving the personalization and accuracy of reaction tests and marketing measures. Application fields include consumer research, educational AI, patient simulation in the medical field, interactive character generation in the entertainment field, and various other fields.

The creation unit can adjust features by referring to past market data during creation of the pseudo persona. The creation unit, for example, adjusts features by referring to past market data. Past market data may include, for example, past sales data or economic indicators, but are not limited thereto. The generative AI, for example, creates a pseudo persona with the most common features based on past market data. The generative AI can also create a pseudo persona with features aligned with specific trends based on past market data. Furthermore, the generative AI can create a pseudo persona with features based on specific consumer behaviors from past market data. Thus, the creation unit can optimize features by referring to past market data, enabling the creation of more accurate pseudo personas. Some or all of the above-described processing in the creation unit may be performed using generative AI or without using generative AI. For example, the creation unit may input past market data to the generative AI, and the generative AI adjusts features of the pseudo persona. Specifically, the creation unit accepts as input past market data such as time-series sales tensors (e.g., 60 months of sales data, 60×1 tensor), time-series economic indicators (e.g., GDP growth rate, unemployment rate, consumer confidence index, etc. as 60×3 tensors), and consumer behavior history tensors (e.g., purchase count, purchase tendency by product category, etc. as 100×12 tensors). Examples of input include “monthly sales data from 2019 to 2023,” “monthly GDP growth rate,” and “purchase history of consumer A for the past year.” The creation unit extracts time-series features from these time-series data using LSTM or Transformer-type neural networks and calculates features such as moving averages, seasonal variation components, and consumer behavior patterns in the trend extraction layer. The creation unit adds these features to the latent feature vector as generation conditions for the generative AI and generates attribute vectors of pseudo personas (e.g., age, gender, purchase tendency, price sensitivity, trend adaptability, etc.) using generative models such as VAE or diffusion models. For example, personas emphasizing purchase tendencies for product categories that have become popular over the past five years or personas with price sensitivity adjusted according to economic indicator fluctuations are generated. Examples of output include “Pseudo Persona A: home appliance oriented, price sensitivity 0.7, trend adaptability 0.9” and “Pseudo Persona B: food oriented, price sensitivity 0.4, trend adaptability 0.6.” The creation unit utilizes weight optimization and conditional generation techniques of the generative AI to realize diverse persona generation based on past data. These processes enable dynamic and automatic feature optimization based on past data, unlike conventional simple average settings or manual attribute adjustments. As a technical effect, the creation unit can generate high-precision personas reflecting market trends and changes in consumer behavior, greatly improving the accuracy and adaptability of reaction tests and marketing measures. Application fields include demand forecasting in retail, advertising targeting, risk assessment for financial products, service design, and various other fields.

The creation unit can set features by focusing on a specific market segment during creation of the pseudo persona. The creation unit, for example, sets features by focusing on a specific market segment. Specific market segments may include, for example, youth market segments, senior market segments, or regional market segments, but are not limited thereto. The generative AI, for example, creates a pseudo persona with features focused on the youth market segment. The generative AI can also create a pseudo persona with features focused on the senior market segment. Furthermore, the generative AI can create a pseudo persona with features focused on regional market segments. Thus, the creation unit can create more targeted pseudo personas by setting features focused on a specific market segment. Some or all of the above-described processing in the creation unit may be performed using generative AI or without using generative AI. For example, the creation unit may input data of a specific market segment to the generative AI, and the generative AI sets features of the pseudo persona based on the data. Specifically, the creation unit accepts as input segment attribute vectors (e.g., age group, gender, region, income class, preferences, etc. as 50-dimensional vectors), segment-specific purchase history tensors (e.g., monthly purchase counts for youth, regional sales trends, etc. as 10×12 tensors), and segment-specific reaction score arrays (e.g., interest scores for new products, etc. as 10-dimensional arrays). Examples of input include vectors such as “18-25 years old, female, urban area, middle income, fashion preference” and “purchase history of elderly in the Kanto region.” The creation unit extracts features from these segment data using Transformer-type neural networks or clustering algorithms and learns latent patterns and purchase tendencies for each segment. The creation unit sets different loss function weights and data sampling ratios for each segment to achieve generation model learning optimized for the target group. The generative AI, based on the extracted segment features, generates segment-specialized pseudo persona attribute vectors (e.g., for youth: new product orientation 0.9, SNS usage frequency 0.8; for seniors: price sensitivity 0.7, health orientation 0.85, etc.) using generative models such as VAE or diffusion models. Examples of output include “Pseudo Persona A: youth, fashion oriented, new product orientation 0.9” and “Pseudo Persona B: senior, health orientation 0.85, price sensitivity 0.7.” These processes enable individual optimization for each target group, unlike conventional overall average-type generation or manual attribute settings. As a technical effect, the creation unit can generate high-precision personas specialized for specific segments, maximizing the effectiveness of marketing measures. Application fields include targeted advertising, regionally focused product development, age group-specific service design, personalized financial products, and various other fields.

The creation unit can estimate user emotions and determine the priority of the pseudo persona based on the estimated user emotions. The creation unit, for example, estimates user emotions and determines the priority of the pseudo persona based on the estimated user emotions. User emotions are estimated using technologies such as emotion analysis or facial expression recognition, for example. The generative AI, for example, prioritizes creating pseudo personas with active features when the user is excited. The generative AI can also prioritize creating pseudo personas with calm features when the user is relaxed. Furthermore, the generative AI can prioritize creating pseudo personas with cool features when the user feels stressed. Thus, the creation unit can prioritize creating more important pseudo personas by determining the priority of the pseudo persona based on user emotions. Emotion estimation is realized using emotion estimation functions with emotion engines or generative AI, for example. The generative AI may be a text generative AI (e.g., LLM) or a multimodal generative AI, but is not limited thereto. Some or all of the above-described processing in the creation unit may be performed using generative AI or without using generative AI. For example, the creation unit may input user emotion data to the generative AI, and the generative AI determines the priority of the pseudo persona. Specifically, the creation unit accepts as input multimodal data for user emotion estimation, such as face image tensors (e.g., 224×224×3), voice waveform data (e.g., 16,000 dimensions), and text utterance data (e.g., 100 tokens). Examples of input include “smiling face image” and “text such as ‘I am looking forward to the new product.’” The creation unit processes these data using CNN or Transformer-type neural networks and outputs emotion labels and scores (e.g., excitement level 0.9, relaxation level 0.7, stress level 0.2). The creation unit assigns priority scores to candidate personas generated by the generative AI based on emotion estimation results and generates and tests personas in order of higher priority. For example, when the excitement level is high, personas with active features are prioritized; when the relaxation level is high, personas with calm features are prioritized; when the stress level is high, personas with cool features are prioritized. Examples of output include “Priority 1: active persona” and “Priority 2: calm persona.” These processes enable dynamic persona prioritization control according to user state, unlike conventional random generation or fixed order generation. As a technical effect, the creation unit can select personas optimized for user concentration and psychological state, thereby improving the efficiency and accuracy of reaction tests and simulations. Application fields include educational AI, personalized marketing, medical diagnostic support, interactive advertising, and various other fields.

The creation unit can set features by considering geographical market characteristics during creation of the pseudo persona. The creation unit, for example, sets features by considering geographical market characteristics. Geographical market characteristics may include, for example, urban market characteristics, rural market characteristics, or international market characteristics, but are not limited thereto. The generative AI, for example, creates a pseudo persona with features considering urban market characteristics. The generative AI can also create a pseudo persona with features considering rural market characteristics. Furthermore, the generative AI can create a pseudo persona with features considering international market characteristics. Thus, the creation unit can create more regionally specialized pseudo personas by setting features considering geographical market characteristics. Some or all of the above-described processing in the creation unit may be performed using generative AI or without using generative AI. For example, the creation unit may input data of geographical market characteristics to the generative AI, and the generative AI sets features of the pseudo persona based on the data. Specifically, the creation unit accepts as input regional attribute vectors (e.g., urban/rural/overseas flag, region code, population density, average income, etc. as 20-dimensional vectors), region-specific purchase history tensors (e.g., monthly sales data for urban, rural, and overseas, 3×12 tensors), and region-specific reaction score arrays (e.g., interest scores for new products by region, 3-dimensional arrays). Examples of input include “urban area: Tokyo, population 14 million, average income 6 million yen” and “rural area: Nagano Prefecture, population 200,000, average income 3.5 million yen.” The creation unit extracts features from these geographical data using Transformer-type neural networks or geospatial clustering algorithms and learns purchase tendencies and reaction patterns for each region. The creation unit sets different loss function weights and data sampling ratios for each region to achieve region-specialized generation model learning. The generative AI, based on the extracted regional features, generates region-specialized pseudo persona attribute vectors (e.g., for urban areas: new product orientation 0.8; for rural areas: price sensitivity 0.9; for overseas: brand orientation 0.85, etc.) using generative models such as VAE or diffusion models. Examples of output include “Pseudo Persona A: urban area, trend orientation 0.8,” “Pseudo Persona B: rural area, price sensitivity 0.9,” and “Pseudo Persona C: overseas, brand orientation 0.85.” These processes enable individual optimization reflecting regional characteristics, unlike conventional nationwide uniform generation or manual attribute settings. As a technical effect, the creation unit can generate personas that accurately reflect consumer behavior and market characteristics for each region, contributing to the optimization of regionally focused marketing and global expansion. Application fields include regional revitalization support, urban service development, overseas market entry strategies, tourism demand forecasting, and various other fields.

The creation unit can analyze social media trends and reflect them in features during creation of the pseudo persona. The creation unit, for example, analyzes social media trends and reflects them in features. Social media trends may include, for example, popular hashtags, influencer posts, or user comments, but are not limited thereto. The generative AI, for example, analyzes popular hashtags on social media and creates a pseudo persona with those features. The generative AI can also analyze influencer posts on social media and create a pseudo persona with those features. Furthermore, the generative AI can analyze user comments on social media and create a pseudo persona with those features. Thus, the creation unit can create pseudo personas based on more up-to-date market data by analyzing social media trends and reflecting them in features. Some or all of the above-described processing in the creation unit may be performed using generative AI or without using generative AI. For example, the creation unit may input social media trend data to the generative AI, and the generative AI reflects those features in the pseudo persona. Specifically, the creation unit accepts as input hashtag frequency vectors (e.g., occurrence counts of 1,000 types of hashtags, 1,000-dimensional vectors), influencer post tensors (e.g., number of posts by 100 people over 12 months, 100×12 tensors), and user comment embedding vectors (e.g., comment vectors encoded by BERT, 768 dimensions). Examples of input include hashtag frequencies such as “#newproduct” and “#buzzword,” “monthly post count of famous influencer A,” and user comments such as “This product is innovative.” The creation unit extracts features from these social media data using natural language processing models or graph neural networks and calculates trending words and topic scores in the trend detection layer. The creation unit adds features with high trend scores to the latent feature vector as generation conditions for the generative AI and generates trend-reflective pseudo persona attribute vectors (e.g., topic score 0.95, influencer impact score 0.88, etc.) using generative models such as VAE or diffusion models. Examples of output include “Pseudo Persona A: topic score 0.95, influencer impact score 0.88” and “Pseudo Persona B: trend orientation 0.9.” These processes enable real-time trend-reflective generation, unlike conventional static data generation or manual attribute settings. As a technical effect, the creation unit can immediately reflect the latest market trends and changes in consumer interest in personas, greatly improving prediction accuracy and responsiveness of marketing measures. Application fields include SNS marketing, brand monitoring, advertising effectiveness measurement, consumer behavior analysis, and various other fields.

The test unit can estimate user emotions and adjust methods of reaction tests based on the estimated user emotions. The test unit, for example, estimates user emotions and adjusts methods of reaction tests based on the estimated user emotions. User emotions are estimated using technologies such as emotion analysis or facial expression recognition, for example. The generative AI, for example, conducts rapid reaction tests when the user is excited. The generative AI can also conduct detailed reaction tests when the user is relaxed. Furthermore, the generative AI can conduct simple reaction tests when the user feels stressed. Thus, the test unit can conduct more appropriate reaction tests by adjusting methods of reaction tests based on user emotions. Emotion estimation is realized using emotion estimation functions with emotion engines or generative AI, for example. The generative AI may be a text generative AI (e.g., LLM) or a multimodal generative AI, but is not limited thereto. Some or all of the above-described processing in the test unit may be performed using generative AI or without using generative AI. For example, the test unit may input user emotion data to the generative AI, and the generative AI adjusts methods of reaction tests. Specifically, the test unit accepts as input multimodal data for user emotion estimation, such as face image tensors (e.g., 224×224×3 RGB images), voice waveform data (e.g., 16,000-dimensional array for 1 second at 16 kHz sampling), and text utterance data (e.g., 100-token natural language sentences). Examples of input include “smiling face image,” “text such as ‘I'm excited about the new product,’” and “voice waveform of excited voice.” The test unit processes these data using CNN or Transformer-type neural networks and outputs emotion labels such as “excited,” “relaxed,” “stressed,” and emotion scores (e.g., excitement level 0.85, relaxation level 0.10, stress level 0.05) in the emotion classification layer. Examples of output include “Emotion label: excited, score 0.92” and “Emotion label: relaxed, score 0.75.” The test unit dynamically adjusts the implementation method of reaction tests (e.g., number of test questions, level of detail, required time, order of presentation, etc.) based on these emotion estimation results. For example, when the excitement level is high, the number of questions is reduced and rapid A/B tests or simple questionnaires are presented. When the relaxation level is high, detailed questions or scenario-based tests are presented. When the stress level is high, only minimal questions or multiple-choice tests are presented. The test unit passes the output results of the generative AI (e.g., test question list, test scenario, estimated required time, etc.) to subsequent reaction data collection modules or the analysis unit. These processes enable dynamic and automatic optimization of test methods according to user state, unlike conventional fixed test design or manual test adjustment. As a technical effect, the test unit can automate optimal test design according to user psychological state and concentration, greatly improving the reliability and efficiency of reaction data collection. In addition, it contributes to improving the quality of user experience and reducing dropout rates. Application fields include consumer research, adaptive testing in educational AI, patient reaction evaluation in the medical field, interactive experience design in the entertainment field, and various other fields.

The test unit can adjust the test algorithm by referring to past test data during reaction tests. For example, the test unit adjusts the test algorithm by referring to past test data. Past test data may include, for example, past test results and test conditions, but is not limited thereto. The generative AI, for example, selects the optimal test algorithm based on past test data. Furthermore, the generative AI can adjust the test algorithm in line with specific trends based on past test data, and can also improve the test algorithm based on specific consumer behaviors derived from past test data. As a result, the test unit can perform more accurate reaction tests by optimizing the test algorithm with reference to past test data. Some or all of the above-described processes in the test unit may be performed using generative AI, or may be performed without generative AI. For example, the test unit inputs past test data to the generative AI, and the generative AI adjusts the test algorithm. Specifically, the test unit accepts as input test result tensors (e.g., test results for 1,000 cases×10 items, 1,000×10 tensor), test condition arrays (e.g., test implementation date and time, target persona attributes, number of test questions, etc., 1,000×5 array), and consumer behavior history tensors (e.g., number of purchases, reaction scores, etc., 1,000×12 tensor) as past test data. Examples of input include “Test result history from January to December 2022,” “Past test reactions of Persona A,” and “Test conditions with 10 questions.” The test unit extracts features from these time-series and multivariate data using LSTM or Transformer-type neural networks, and calculates past test patterns, reaction trends, and algorithm performance indicators (e.g., accuracy rate, reaction speed, dropout rate, etc.) in a trend extraction layer. Based on these feature quantities, the test unit automatically optimizes the hyperparameters of the test algorithm (e.g., number of questions, question difficulty, test branching conditions, presentation order, etc.). For example, it avoids question patterns with high dropout rates in the past and prioritizes question structures with high reaction accuracy. Furthermore, the test unit detects past trend change points and consumer behavior patterns, and can dynamically change the logic of the test algorithm (e.g., branching conditions, scoring methods). Examples of output include “Change number of questions from 8 to 6,” “Change branching condition from A to B,” etc. These processes realize dynamic optimization based on past data, which differs from conventional static test design and manual algorithm adjustment. As a technical effect, the test unit enables highly accurate test design reflecting past test history and changes in consumer behavior, greatly improving the reliability and efficiency of reaction data collection. Application fields include optimization of consumer surveys, adaptive testing in educational AI, patient evaluation protocol design in the medical field, and user experience optimization in the entertainment field.

The test unit can conduct tests by focusing on a specific market segment during reaction tests. For example, the test unit conducts tests by focusing on a specific market segment. Specific market segments may include, for example, youth market segments, senior market segments, and regional market segments, but are not limited thereto. The generative AI, for example, focuses on the youth market segment and conducts reaction tests based on its data. The generative AI can also focus on the senior market segment and conduct reaction tests based on its data, and further focus on regional market segments and conduct reaction tests based on their data. As a result, the test unit can conduct more targeted reaction tests by focusing on specific market segments. Some or all of the above-described processes in the test unit may be performed using generative AI, or may be performed without generative AI. For example, the test unit inputs data of a specific market segment to the generative AI, and the generative AI conducts reaction tests based on that data. Specifically, the test unit accepts as input segment attribute vectors (e.g., age group, gender, region, income class, preferences, etc., 50-dimensional vector), segment-specific purchase history tensors (e.g., monthly purchase frequency for youth, regional sales trends, etc., 10×12 tensor), and segment-specific reaction score arrays (e.g., interest scores for new products, etc., 10-dimensional array). Examples of input include vectors such as “18-25 years old, female, urban area, middle income, fashion preference” and “purchase history of seniors in the Kanto region.” The test unit extracts features from these segment data using Transformer-type neural networks or clustering algorithms, and learns latent patterns and purchasing trends for each segment. The test unit automatically generates different test questions, scenarios, and evaluation criteria for each segment, and conducts reaction tests optimized for the target group. For example, it presents questions about new product orientation and SNS usage to the youth segment, and questions about price sensitivity and health orientation to the senior segment. Examples of output include “Test question list for youth segment” and “Test scenario for senior segment.” The test unit passes the test results to subsequent reaction data collection and analysis units based on the output results of the generative AI (e.g., test question list, test scenario, evaluation criteria, etc.). These processes enable individual optimization for each target group, which differs from conventional overall average-type tests and manual question design. As a technical effect, the test unit enables highly accurate reaction tests specialized for specific segments, maximizing the effectiveness of marketing measures and product development. Application fields include targeted advertising, regionally focused product development, age group-specific service design, and personalization of financial products, among others.

The test unit can estimate user emotions and determine the priority of reaction tests based on the estimated user emotions. For example, the test unit estimates user emotions and determines the priority of reaction tests based on the estimated user emotions. User emotions are estimated using technologies such as emotion analysis and facial expression recognition. The generative AI, for example, prioritizes important reaction tests when the user is excited. The generative AI can also prioritize detailed reaction tests when the user is relaxed, and prioritize simple reaction tests when the user is stressed. As a result, the test unit can prioritize more important reaction tests by determining the priority of reaction tests based on user emotions. Emotion estimation is realized using emotion estimation functions such as emotion engines or generative AI. The generative AI may be a text generative AI (e.g., LLM) or a multimodal generative AI, but is not limited thereto. Some or all of the above-described processes in the test unit may be performed using generative AI, or may be performed without generative AI. For example, the test unit inputs user emotion data to the generative AI, and the generative AI determines the priority of reaction tests. Specifically, the test unit accepts as input multimodal data for user emotion estimation, such as facial image tensors (e.g., 224×224×3), audio waveform data (e.g., 16,000 dimensions), and text utterance data (e.g., 100 tokens). Examples of input include “smiling face image” and “text saying ‘I am looking forward to the new product.’” The test unit processes these data using CNN or Transformer-type neural networks, and outputs emotion labels and scores (e.g., excitement level 0.9, relaxation level 0.7, stress level 0.2). Based on the emotion estimation results, the test unit assigns priority scores to the reaction test candidate list and conducts tests in order of highest priority. For example, when the excitement level is high, tests related to new products or important market changes are prioritized; when the relaxation level is high, detailed attribute tests or supplementary tests are prioritized; and when the stress level is high, simple or basic tests are prioritized. Examples of output include “Priority 1: New product test” and “Priority 2: Detailed attribute test.” The test unit passes the test results to subsequent reaction data collection and analysis units based on the output results of the generative AI (e.g., test priority list, test execution order, etc.). These processes realize dynamic test priority control according to user state, which differs from conventional random sampling or fixed order tests. As a technical effect, the test unit enables test selection optimized for user concentration and psychological state, thereby improving the reliability and efficiency of reaction data collection. Application fields include educational AI, personalized marketing, medical diagnostic support, interactive advertising, and many others.

The test unit can conduct tests by considering geographical market characteristics during reaction tests. For example, the test unit conducts tests by considering geographical market characteristics. Geographical market characteristics may include, for example, urban market characteristics, rural market characteristics, and international market characteristics, but are not limited thereto. The generative AI, for example, considers urban market characteristics and conducts reaction tests based on its data. The generative AI can also consider rural market characteristics and conduct reaction tests based on its data, and further consider international market characteristics and conduct reaction tests based on their data. As a result, the test unit can conduct more region-specific reaction tests by considering geographical market characteristics. Some or all of the above-described processes in the test unit may be performed using generative AI, or may be performed without generative AI. For example, the test unit inputs data on geographical market characteristics to the generative AI, and the generative AI conducts reaction tests based on that data. Specifically, the test unit accepts as input regional attribute vectors (e.g., urban/rural/overseas flag, region code, population density, average income, etc., 20-dimensional vector), region-specific purchase history tensors (e.g., monthly sales data for urban, rural, and overseas areas, 3×12 tensor), and region-specific reaction score arrays (e.g., interest scores for new products by region, 3-dimensional array). Examples of input include “Urban area: Tokyo, population 14 million, average income 6 million yen” and “Rural area: Nagano Prefecture, population 200,000, average income 3.5 million yen.” The test unit extracts features from these geographical data using Transformer-type neural networks or geospatial clustering algorithms, and learns purchasing trends and reaction patterns for each region. The test unit automatically generates different test questions, scenarios, and evaluation criteria for each region, and conducts region-specific reaction tests. For example, it presents questions about trend orientation and brand awareness to urban areas, questions about price sensitivity and local orientation to rural areas, and questions about cultural adaptability and local needs to overseas markets. Examples of output include “Test question list for urban areas,” “Test scenario for rural areas,” and “Evaluation criteria for overseas markets.” The test unit passes the test results to subsequent reaction data collection and analysis units based on the output results of the generative AI (e.g., test question list, test scenario, evaluation criteria, etc.). These processes enable individual optimization reflecting regional characteristics, which differs from conventional nationwide uniform tests and manual question design. As a technical effect, the test unit enables highly accurate test design reflecting consumer behavior and market characteristics for each region, contributing to the optimization of regionally focused marketing and global expansion. Application fields include regional revitalization support, urban service development, overseas market entry strategies, and demand forecasting in the tourism industry, among others.

The test unit can analyze social media trends and reflect them in tests during reaction tests. For example, the test unit analyzes social media trends and reflects them in tests. Social media trends may include, for example, popular hashtags, influencer posts, and user comments, but are not limited thereto. The generative AI, for example, analyzes popular hashtags on social media and conducts reaction tests based on their data. The generative AI can also analyze influencer posts on social media and conduct reaction tests based on their data, and further analyze user comments on social media and conduct reaction tests based on their data. As a result, the test unit can conduct reaction tests based on the latest market data by analyzing social media trends and reflecting them in tests. Some or all of the above-described processes in the test unit may be performed using generative AI, or may be performed without generative AI. For example, the test unit inputs social media trend data to the generative AI, and the generative AI conducts reaction tests based on that data. Specifically, the test unit accepts as input hashtag frequency vectors (e.g., occurrence counts for 1,000 types of hashtags, 1,000-dimensional vector), influencer post tensors (e.g., number of posts by 100 influencers over 12 months, 100×12 tensor), and user comment embedding vectors (e.g., comment vectors encoded by BERT, 768 dimensions). Examples of input include hashtag frequencies such as “#newproduct” and “#buzzword,” “monthly post count of famous influencer A,” and user comments such as “This product is revolutionary.” The test unit extracts features from these social media data using natural language processing models or graph neural networks, and calculates rapidly rising words and topic scores in a trend detection layer. The test unit assigns topics and influencer posts with high trend scores as generation conditions to the generative AI, and generates trend-reflecting test questions and scenarios using generative models such as VAE or diffusion models. Examples of output include “Trend hashtag question: #newproduct,” “Scenario reflecting influencer post,” and “Topic score 0.95.” The test unit passes the test results to subsequent reaction data collection and analysis units based on the output results of the generative AI (e.g., test question list, test scenario, topic score, etc.). These processes realize real-time trend-reflecting tests, which differ from conventional static data tests and manual question design. As a technical effect, the test unit can immediately reflect the latest market trends and changes in consumer interest in test design, greatly improving the freshness of reaction data and the responsiveness of marketing measures. Application fields include SNS marketing, brand monitoring, advertising effectiveness measurement, and consumer behavior analysis, among others.

The analysis unit can estimate user emotions and adjust the method of analyzing test results based on the estimated user emotions. For example, the analysis unit estimates user emotions and adjusts the method of analyzing test results based on the estimated user emotions. User emotions are estimated using technologies such as emotion analysis and facial expression recognition. The generative AI, for example, performs rapid analysis when the user is excited. The generative AI can also perform detailed analysis when the user is relaxed, and perform simple analysis when the user is stressed. As a result, the analysis unit can perform more appropriate analysis by adjusting the method of analyzing test results based on user emotions. Emotion estimation is realized using emotion estimation functions such as emotion engines or generative AI. The generative AI may be a text generative AI (e.g., LLM) or a multimodal generative AI, but is not limited thereto. Some or all of the above-described processes in the analysis unit may be performed using generative AI, or may be performed without generative AI. For example, the analysis unit inputs user emotion data to the generative AI, and the generative AI adjusts the method of analyzing test results. Specifically, the analysis unit accepts as input multimodal data for user emotion estimation, such as facial image tensors (e.g., 224×224×3 RGB images), audio waveform data (e.g., 16,000-dimensional array sampled at 16 kHz for 1 second), and text utterance data (e.g., 100-token natural language sentences). Examples of input include “smiling face image,” “text saying ‘I'm excited about the new product,’” and “audio waveform of an excited voice.” The analysis unit processes these data using CNN or Transformer-type neural networks, and outputs emotion labels such as “excited,” “relaxed,” “stressed,” and emotion scores (e.g., excitement level 0.85, relaxation level 0.10, stress level 0.05) in an emotion classification layer. Examples of output include “Emotion label: excited, score 0.92” and “Emotion label: relaxed, score 0.75.” Based on these emotion estimation results, the analysis unit dynamically adjusts analysis methods (e.g., simple aggregation, detailed multivariate analysis, summary report generation, detailed report generation, etc.) and analysis granularity (e.g., aggregation unit, number of variables, visualization method, etc.) in an analysis method selection module. For example, when the excitement level is high, rapid aggregation of key indicators and dashboard display are prioritized; when the relaxation level is high, detailed clustering, regression analysis, principal component analysis, and other multivariate analyses are performed; and when the stress level is high, simple summary reports or analysis of only key indicators are performed. The analysis unit passes analysis results (e.g., reaction distribution by target group, price optimization proposals, advertising channel recommendations, etc.) to subsequent decision support modules or report generation modules. These processes enable dynamic and automatic optimization of analysis methods according to user state, which differs from conventional fixed analysis methods and manual analysis design. As a technical effect, the analysis unit can automate optimal analysis design according to user psychological state and concentration, greatly improving the reliability and efficiency of analysis results. It also contributes to improving the quality of user experience and the efficiency of analysis operations. Application fields include consumer survey analysis, adaptive performance analysis in educational AI, patient evaluation analysis in the medical field, and user experience analysis in the entertainment field, among others.

The analysis unit can adjust the analysis algorithm by referring to past analysis data during analysis of test results. For example, the analysis unit adjusts the analysis algorithm by referring to past analysis data. Past analysis data may include, for example, past analysis results and analysis conditions, but is not limited thereto. The generative AI, for example, selects the optimal analysis algorithm based on past analysis data. Furthermore, the generative AI can adjust the analysis algorithm in line with specific trends based on past analysis data, and can also improve the analysis algorithm based on specific consumer behaviors derived from past analysis data. As a result, the analysis unit can perform more accurate analysis by optimizing the analysis algorithm with reference to past analysis data. Some or all of the above-described processes in the analysis unit may be performed using generative AI, or may be performed without generative AI. For example, the analysis unit inputs past analysis data to the generative AI, and the generative AI adjusts the analysis algorithm. Specifically, the analysis unit accepts as input analysis result tensors (e.g., analysis results for 1,000 cases×20 items, 1,000×20 tensor), analysis condition arrays (e.g., analysis implementation date and time, target persona attributes, analysis method type, etc., 1,000×5 array), and consumer behavior history tensors (e.g., number of purchases, reaction scores, etc., 1,000×12 tensor) as past analysis data. Examples of input include “Analysis result history from January to December 2022,” “Past analysis results of Persona A,” and “Analysis conditions using clustering methods.” The analysis unit extracts features from these time-series and multivariate data using LSTM or Transformer-type neural networks, and calculates past analysis patterns and algorithm performance indicators (e.g., analysis accuracy, processing speed, error rate, etc.) in a trend extraction layer. Based on these feature quantities, the analysis unit automatically optimizes the hyperparameters of the analysis algorithm (e.g., number of clusters, number of principal components, regularization coefficient of regression models, etc.) and analysis methods (e.g., clustering, regression analysis, principal component analysis, association analysis, etc.). For example, it prioritizes methods with high analysis accuracy in the past and avoids methods with high error rates. Furthermore, the analysis unit detects past trend change points and consumer behavior patterns, and can dynamically change the logic of the analysis algorithm (e.g., feature selection, weighting methods). Examples of output include “Change number of clusters from 5 to 8,” “Change regularization coefficient of regression model from 0.1 to 0.05,” etc. These processes realize dynamic optimization based on past data, which differs from conventional static analysis design and manual algorithm adjustment. As a technical effect, the analysis unit enables highly accurate analysis design reflecting past analysis history and changes in consumer behavior, greatly improving the reliability and efficiency of analysis results. Application fields include optimization of consumer surveys, performance analysis in educational AI, patient evaluation protocol design in the medical field, and user experience optimization in the entertainment field.

The analysis unit can conduct analysis by focusing on a specific market segment during analysis of test results. For example, the analysis unit conducts analysis by focusing on a specific market segment. Specific market segments may include, for example, youth market segments, senior market segments, and regional market segments, but are not limited thereto. The generative AI, for example, focuses on the youth market segment and conducts analysis based on its data. The generative AI can also focus on the senior market segment and conduct analysis based on its data, and further focus on regional market segments and conduct analysis based on their data. As a result, the analysis unit can conduct more targeted analysis by focusing on specific market segments. Some or all of the above-described processes in the analysis unit may be performed using generative AI, or may be performed without generative AI. For example, the analysis unit inputs data of a specific market segment to the generative AI, and the generative AI conducts analysis based on that data. Specifically, the analysis unit accepts as input segment attribute vectors (e.g., age group, gender, region, income class, preferences, etc., 50-dimensional vector), segment-specific purchase history tensors (e.g., monthly purchase frequency for youth, regional sales trends, etc., 10×12 tensor), and segment-specific reaction score arrays (e.g., interest scores for new products, etc., 10-dimensional array). Examples of input include vectors such as “18-25 years old, female, urban area, middle income, fashion preference” and “purchase history of seniors in the Kanto region.” The analysis unit extracts features from these segment data using Transformer-type neural networks or clustering algorithms, and analyzes latent patterns and purchasing trends for each segment. The analysis unit sets different analysis methods, weighting, and visualization methods for each segment, and realizes analysis optimized for the target group. Examples of output include “Purchasing trend of youth segment: new product orientation” and “Price sensitivity of senior segment: high.” These processes enable individual optimization for each target group, which differs from conventional overall average-type analysis and manual analysis design. As a technical effect, the analysis unit enables highly accurate market analysis and demand analysis specialized for specific segments, maximizing the effectiveness of marketing measures. Application fields include targeted advertising, regionally focused product development, age group-specific service design, and personalization of financial products, among others.

The analysis unit can estimate user emotions and determine the priority of test results based on the estimated user emotions. For example, the analysis unit estimates user emotions and determines the priority of test results based on the estimated user emotions. User emotions are estimated using technologies such as emotion analysis and facial expression recognition. The generative AI, for example, prioritizes analysis of important test results when the user is excited. The generative AI can also prioritize analysis of detailed test results when the user is relaxed, and prioritize analysis of simple test results when the user is stressed. As a result, the analysis unit can prioritize analysis of more important test results by determining the priority of test results based on user emotions. Emotion estimation is realized using emotion estimation functions such as emotion engines or generative AI. The generative AI may be a text generative AI (e.g., LLM) or a multimodal generative AI, but is not limited thereto. Some or all of the above-described processes in the analysis unit may be performed using generative AI, or may be performed without generative AI. For example, the analysis unit inputs user emotion data to the generative AI, and the generative AI determines the priority of test results. Specifically, the analysis unit accepts as input multimodal data for user emotion estimation, such as facial image tensors (e.g., 224×224×3), audio waveform data (e.g., 16,000 dimensions), and text utterance data (e.g., 100 tokens). Examples of input include “smiling face image” and “text saying ‘I am looking forward to the new product.’” The analysis unit processes these data using CNN or Transformer-type neural networks, and outputs emotion labels and scores (e.g., excitement level 0.9, relaxation level 0.7, stress level 0.2). Based on the emotion estimation results, the analysis unit assigns priority scores to the test result list and analyzes test results in order of highest priority. For example, when the excitement level is high, test results related to new products or important market changes are prioritized; when the relaxation level is high, detailed attribute test results or supplementary test results are prioritized; and when the stress level is high, simple or basic test results are prioritized. Examples of output include “Priority 1: New product test result” and “Priority 2: Detailed attribute test result.” These processes realize dynamic analysis priority control according to user state, which differs from conventional random sampling or fixed order analysis. As a technical effect, the analysis unit enables analysis selection optimized for user concentration and psychological state, thereby improving analysis efficiency and the reliability of results. Application fields include educational AI, personalized marketing, medical diagnostic support, interactive advertising, and many others.

The analysis unit can conduct analysis by considering geographical market characteristics during analysis of test results. For example, the analysis unit conducts analysis by considering geographical market characteristics. Geographical market characteristics may include, for example, urban market characteristics, rural market characteristics, and international market characteristics, but are not limited thereto. The generative AI, for example, considers urban market characteristics and conducts analysis based on its data. The generative AI can also consider rural market characteristics and conduct analysis based on its data, and further consider international market characteristics and conduct analysis based on their data. As a result, the analysis unit can conduct more region-specific analysis by considering geographical market characteristics. Some or all of the above-described processes in the analysis unit may be performed using generative AI, or may be performed without generative AI. For example, the analysis unit inputs data on geographical market characteristics to the generative AI, and the generative AI conducts analysis based on that data. Specifically, the analysis unit accepts as input regional attribute vectors (e.g., urban/rural/overseas flag, region code, population density, average income, etc., 20-dimensional vector), region-specific purchase history tensors (e.g., monthly sales data for urban, rural, and overseas areas, 3×12 tensor), and region-specific reaction score arrays (e.g., interest scores for new products by region, 3-dimensional array). Examples of input include “Urban area: Tokyo, population 14 million, average income 6 million yen” and “Rural area: Nagano Prefecture, population 200,000, average income 3.5 million yen.” The analysis unit extracts features from these geographical data using Transformer-type neural networks or geospatial clustering algorithms, and analyzes purchasing trends and reaction patterns for each region. The analysis unit sets different analysis methods, weighting, and visualization methods for each region, and realizes region-specific analysis. Examples of output include “New product orientation in urban areas: high,” “Price sensitivity in rural areas: high,” and “Brand orientation in overseas markets: strong.” These processes enable individual optimization reflecting regional characteristics, which differs from conventional nationwide uniform analysis and manual analysis design. As a technical effect, the analysis unit enables highly accurate analysis reflecting consumer behavior and market characteristics for each region, contributing to the optimization of regionally focused marketing and global expansion. Application fields include regional revitalization support, urban service development, overseas market entry strategies, and demand forecasting in the tourism industry, among others.

The analysis unit can analyze social media trends and reflect them in results during analysis of test results. For example, the analysis unit analyzes social media trends and reflects them in results. Social media trends may include, for example, popular hashtags, influencer posts, and user comments, but are not limited thereto. The generative AI, for example, analyzes popular hashtags on social media and conducts analysis based on their data. The generative AI can also analyze influencer posts on social media and conduct analysis based on their data, and further analyze user comments on social media and conduct analysis based on their data. As a result, the analysis unit can conduct analysis based on the latest market data by analyzing social media trends and reflecting them in results. Some or all of the above-described processes in the analysis unit may be performed using generative AI, or may be performed without generative AI. For example, the analysis unit inputs social media trend data to the generative AI, and the generative AI conducts analysis based on that data. Specifically, the analysis unit accepts as input hashtag frequency vectors (e.g., occurrence counts for 1,000 types of hashtags, 1,000-dimensional vector), influencer post tensors (e.g., number of posts by 100 influencers over 12 months, 100×12 tensor), and user comment embedding vectors (e.g., comment vectors encoded by BERT, 768 dimensions). Examples of input include hashtag frequencies such as “#newproduct” and “#buzzword,” “monthly post count of famous influencer A,” and user comments such as “This product is revolutionary.” The analysis unit extracts features from these social media data using natural language processing models or graph neural networks, and calculates rapidly rising words and topic scores in a trend detection layer. The analysis unit reflects topics and influencer posts with high trend scores in analysis results, and outputs decision support information considering the latest trends (e.g., reaction distribution for trend hashtags, influencer impact analysis, reports with topic scores, etc.). Examples of output include “Trend hashtag: #newproduct, score 0.95” and “Trending influencer: A, impact score 0.88.” These processes realize real-time trend-reflecting analysis, which differs from conventional static data analysis and manual analysis design. As a technical effect, the analysis unit can immediately reflect the latest market trends and changes in consumer interest in analysis results, greatly improving the freshness of analysis results and the responsiveness of marketing measures. Application fields include SNS marketing, brand monitoring, advertising effectiveness measurement, and consumer behavior analysis, among others.

The system according to the embodiment is not limited to the above examples, and various modifications are possible, for example, as described below. Specifically, the system can be expanded in various ways on both hardware and software aspects, such as modularization of each component, API integration, introduction of distributed processing architecture, adoption of cloud-based data storage, and high-speed computing environments using GPU clusters. The system can utilize a combination of multiple neural network architectures, such as CNN, RNN, Transformer, VAE, and diffusion models. Furthermore, the system can flexibly accept various data types as input and output formats, such as image tensors (e.g., 224×224×3), time-series arrays (e.g., 60×1), natural language text (e.g., 100 tokens), and categorical vectors (e.g., 50 dimensions). In addition, the system can add modules for hyperparameter optimization and automatic feature extraction engines to automate the AI model training and inference pipeline. For example, the learning unit can introduce advanced learning methods such as online learning, transfer learning, and meta-learning to adapt to market changes in real time. The creation unit can enhance conditional generation and diversity control functions of generative models to realize more diverse persona generation. The test unit can add scenario auto-generation and user state-adaptive test design functions to improve the flexibility and accuracy of reaction tests. The analysis unit can incorporate anomaly detection, causal inference, and explainable AI (XAI) modules to improve the reliability and explainability of analysis results. Through these enhancements, the system realizes advanced computer technology, such as collaboration among multiple AI models, dynamic pipeline control, and real-time analysis of high-dimensional data, which differs from conventional single-model and static processing systems. As a technical effect, the system can greatly improve responsiveness to market changes, model accuracy, data processing efficiency, and the quality of user experience. Application fields include consumer surveys, advertising optimization, financial risk assessment, medical diagnostic support, educational AI, and interactive experience design in the entertainment field, among many others.

The market reaction prediction system may further comprise a feedback collection unit. The feedback collection unit collects feedback from actual consumers and inputs it to the generative AI to improve the accuracy of the pseudo persona. For example, it collects consumer impressions of new products from surveys or review sites and inputs the data to the generative AI. It can also collect consumer posts and comments on social media and input them to the generative AI. Furthermore, it can collect data on consumer experiences and satisfaction when actually using new products and input the data to the generative AI. As a result, the feedback collection unit can improve the accuracy of the pseudo persona based on feedback from actual consumers. Specifically, the feedback collection unit automatically collects and normalizes various data such as consumer survey data (e.g., 5-point rating scores for each question, free-text comments), rating score arrays from review sites (e.g., 1,000 ratings per product, 1,000×1 tensor), social media post text (e.g., up to 280 characters per post), and image/video data (e.g., product usage scene images 224×224×3, video frame sequences), and performs preprocessing such as noise removal, language unification, and anonymization, then structures the data as input tensors for the generative AI. Examples of input include comments such as “This product is easy to use,” rating score 4.5, and “#newproductexperience.” The feedback collection unit extracts features from these data using natural language processing models (e.g., BERT, Transformer), image recognition models (e.g., CNN), and time-series analysis models (e.g., LSTM), and inputs multidimensional feature vectors such as consumer emotion scores, satisfaction indicators, and topic scores to the generative AI. The generative AI reflects these real data-derived features in persona generation conditions and model weight optimization, and generates highly accurate pseudo personas close to actual consumer behavior and preferences using generative models such as VAE or diffusion models. Examples of output include “Pseudo Persona A: Satisfaction 0.92, Topic score 0.85” and “Pseudo Persona B: Dissatisfaction 0.3, Improvement request: price.” The feedback collection unit also detects time-series changes and anomalies in the collected data, and can be used for continuous model updates and detection of abnormal behavior patterns. These processes, unlike conventional manual aggregation and static attribute setting, directly reflect real-time and diverse consumer feedback in AI models, greatly improving model realism, accuracy, and adaptability. As a technical effect, the feedback collection unit can immediately reflect the latest market trends and changes in consumer psychology in persona generation, dramatically improving the accuracy and responsiveness of marketing measures and product development. Application fields include consumer surveys, product development, advertising effectiveness measurement, brand monitoring, and customer support analysis, among many others.

The learning unit may further comprise a real-time data collection function. The real-time data collection function collects market trends in real time and inputs them to the generative AI, enabling quicker response to market changes. For example, it collects real-time sales data and inventory data and inputs them to the generative AI. It can also collect real-time consumer purchasing behavior data and input them to the generative AI. Furthermore, it can collect real-time competitor trend data and input them to the generative AI. As a result, the learning unit can respond quickly to market changes using the real-time data collection function. Specifically, the learning unit automatically collects data such as sales time-series tensors (e.g., 1-minute interval sales data, 1,440×1), inventory quantity arrays (e.g., inventory count per SKU, 100×1), purchase behavior event logs (e.g., user ID, product ID, time, action type, 10,000×4 array), and competitor price/promotion information (e.g., price change time-series per competitor product, 50×24 tensor) from IoT sensors, POS systems, EC site APIs, SNS streaming APIs, etc., on a second or minute basis. Examples of input include “10 sales at 10:00 on June 1, 2024,” “Inventory of product A: 50,” and “Competitor B price change event.” The learning unit batches and normalizes these real-time data using stream processing platforms (e.g., Kafka, Spark Streaming), performs anomaly detection and missing value imputation, and extracts time-series features using LSTM or Transformer-type neural networks. The learning unit immediately reflects the extracted features (e.g., sudden sales increase, inventory shortage signal, competitor price trend, etc.) in the generative AI learning pipeline, and dynamically adjusts model weights and hyperparameters (e.g., learning rate, batch size). Examples of output include “Change learning rate from 0.01 to 0.05” and “New trend detected: competitor price reduction.” Furthermore, the learning unit can automatically trigger model retraining or ensemble model switching based on anomaly detection or trend change point detection in real-time data. These processes realize real-time AI learning control in response to market changes, which differs from conventional batch-type and static data learning. As a technical effect, the learning unit can immediately respond to sudden market changes and unexpected events, greatly improving model prediction accuracy, adaptability, and operational efficiency. Application fields include demand forecasting, inventory optimization, dynamic pricing, real-time ad delivery, financial transaction monitoring, and many others.

The creation unit may further comprise a multilingual support function. The multilingual support function enables learning of market data in different languages and creation of pseudo personas in multiple languages. For example, it learns market data in English, Spanish, Chinese, etc., and creates pseudo personas corresponding to each language. The multilingual support function can also create pseudo personas based on different cultures and customs. Furthermore, it can create pseudo personas considering market characteristics of different regions. As a result, the creation unit can create pseudo personas corresponding to different languages and cultures using the multilingual support function. Specifically, the creation unit accepts as input multilingual text data (e.g., review texts in English, Spanish, Chinese, 100 tokens each), multilingual attribute vectors (e.g., language ID, region code, culture flag, 10-dimensional vector), and multilingual purchase history tensors (e.g., monthly purchase frequency per language region, 5×12 tensor). Examples of input include “English: ‘Easy to use’,” “Chinese: ‘ [symbol] ’,” and “Spanish: ‘Muy práctico’.” The creation unit extracts features from these multilingual data using multilingual pre-trained models (e.g., mBERT, XLM-R), multilingual Transformer models, and cross-lingual embedding models, and learns consumer behavior patterns and preference trends for each language and culture. The creation unit assigns the extracted multilingual and multicultural features as latent feature vectors to the generative AI's generation conditions, and generates multilingual and multicultural pseudo persona attribute vectors (e.g., language adaptability, cultural adaptability, regional characteristic scores) using generative models such as VAE or diffusion models. Examples of output include “Pseudo Persona A: English-speaking, trend orientation 0.8,” “Pseudo Persona B: Chinese-speaking, price sensitivity 0.7,” and “Pseudo Persona C: Spanish-speaking, health orientation 0.9.” Furthermore, the creation unit sets different loss function weights and data sampling ratios for each region to realize language-and culture-specific generative model training. These processes, unlike conventional single-language and single-culture generation or manual attribute setting, enable highly accurate persona generation reflecting market characteristics of multiple languages, cultures, and regions. As a technical effect, the creation unit can greatly improve the accuracy and adaptability of global market expansion and multicultural marketing. Application fields include global product development, multilingual ad delivery, region-specific service design, and international brand strategy, among many others.

The test unit may further comprise a virtual reality (VR) test function. The virtual reality test function enables testing of pseudo personas in a virtual reality environment. For example, it introduces a new product to a pseudo persona in a virtual reality environment and observes its reaction. It can also simulate consumer purchasing behavior in a virtual reality environment and collect the data. Furthermore, it can observe consumer experience and satisfaction in a virtual reality environment and collect the data. As a result, the test unit can conduct more realistic reaction tests using the virtual reality test function. Specifically, the test unit accepts as input VR environment scenario data (e.g., 3D spatial coordinate sequences, user gaze tracking data, interaction event logs), in-VR purchasing behavior tensors (e.g., number of product selections, time spent, gaze movement patterns, 100×10 tensor), and in-VR emotional reaction data (e.g., facial expression change frame sequences, voice tone changes, biometrics data). Examples of input include “Action of picking up product A in VR,” “3 minutes of gaze concentration,” and “Utterance: ‘Easy to use.’” The test unit extracts features from these VR data using 3D spatial analysis models (e.g., PointNet, 3D-CNN), time-series analysis models (e.g., LSTM), and multimodal emotion estimation models (e.g., integrated models for voice, facial expression, and biometric signals), and calculates consumer purchase intent scores, satisfaction indicators, and interaction patterns. The test unit inputs reaction data in the VR environment to the generative AI, models behavior patterns and emotional changes for each persona, and utilizes them for VR scenario optimization and product design feedback. Examples of output include “In-VR purchase intent score: 0.88,” “Satisfaction: 0.92,” and “Gaze concentration pattern: product A→B→C.” Furthermore, the test unit can automatically adjust VR environment parameters (e.g., product placement, lighting, sound effects) to efficiently conduct A/B tests and multivariate tests. These processes, unlike conventional questionnaires or tests on 2D screens, contribute to the advancement of computer technology by enabling high-precision reproduction and analysis of consumer behavior in immersive and highly realistic virtual environments. As a technical effect, the test unit can greatly improve the accuracy and reliability of UX evaluation for new products and services, purchasing behavior analysis, and emotional response measurement. Application fields include product development, store design, ad experience design, and VR simulation in education and medical fields, among many others.

The analysis unit may further comprise a predictive analysis function. The predictive analysis function enables prediction of future market trends based on test results. For example, it predicts sales of new products based on test results. It can also predict changes in consumer purchase intent based on test results. Furthermore, it can predict competitor trends based on test results. As a result, the analysis unit can predict future market trends using the predictive analysis function and formulate more effective marketing strategies. Specifically, the analysis unit accepts as input test result tensors (e.g., reaction data for 1,000 cases×10 items), time-series purchase intent score arrays (e.g., 12 months of intent scores per user, 1,000×12 tensor), and competitor trend time-series data (e.g., sales and price changes per competitor product, 50×24 tensor). Examples of input include “New product test reactions for June 2024,” “Time-series purchase intent scores for user A,” and “Price trends for competitor B.” The analysis unit processes these data using time-series prediction models (e.g., LSTM, Transformer), regression analysis models, and Bayesian inference models, and calculates future sales forecast values, purchase intent trends, and probability distributions of competitor share changes. Examples of output include “New product sales forecast: 5,000 units in the first month,” “Purchase intent upward trend: 0.85,” and “Probability of competitor share decrease: 0.7.” The analysis unit passes the prediction results to marketing strategy proposal modules and dashboard display modules, and utilizes them for optimization of ad budget allocation, product launch timing, and promotion measures. Furthermore, the analysis unit can automatically perform accuracy evaluation of prediction models, anomaly detection, and scenario simulation (e.g., sales forecast when changing prices). These processes realize dynamic predictive analysis of high-dimensional and multivariate data by AI, which differs from conventional simple aggregation and manual prediction. As a technical effect, the analysis unit can greatly improve responsiveness to market changes, prediction accuracy, and strategy formulation efficiency. Application fields include demand forecasting, ad effectiveness prediction, competitor analysis, risk assessment, and supply chain optimization, among many others.

The learning unit can estimate user emotions and adjust the content of market data learning based on the estimated user emotions. For example, when the user is excited, the learning unit prioritizes learning of positive market data. When the user is relaxed, the learning unit can learn detailed market data. Furthermore, when the user is stressed, the learning unit can learn simple market data. As a result, the learning unit can perform more appropriate learning by adjusting the content of market data learning based on user emotions. Specifically, the learning unit accepts as input multimodal data for user emotion estimation, such as facial image tensors (e.g., 224×224×3), audio waveform data (e.g., 16,000 dimensions), and text utterance data (e.g., 100 tokens). Examples of input include “smiling face image” and “text saying ‘I'm excited about the new product.’” The learning unit processes these data using CNN or Transformer-type neural networks, and outputs emotion labels such as “excited,” “relaxed,” “stressed,” and emotion scores (e.g., excitement level 0.85, relaxation level 0.10, stress level 0.05) in an emotion classification layer. Examples of output include “Emotion label: excited, score 0.92” and “Emotion label: relaxed, score 0.75.” Based on the emotion estimation results, the learning unit assigns priority scores to each data in the learning dataset, and when the excitement level is high, prioritizes learning of new products and positive market data; when the relaxation level is high, prioritizes learning of detailed attribute data and supplementary data; and when the stress level is high, prioritizes learning of simple or basic data. The learning unit dynamically adjusts batch learning and data sampling ratios based on priority scores, constructing a learning pipeline optimized for user state. These processes realize dynamic data priority control according to user state, which differs from conventional random sampling and fixed order learning. As a technical effect, the learning unit enables selection of learning data optimized for user concentration and psychological state, thereby improving learning efficiency and model accuracy. Application fields include educational AI, personalized marketing, medical diagnostic support, interactive advertising, and many others.

The creation unit can estimate user emotions and adjust the behavior patterns of pseudo personas based on the estimated user emotions. For example, when the user is excited, the creation unit creates a pseudo persona with an active behavior pattern. When the user is relaxed, the creation unit can create a pseudo persona with a calm behavior pattern. Furthermore, when the user is stressed, the creation unit can create a pseudo persona with a composed behavior pattern. As a result, the creation unit can create more appropriate pseudo personas by adjusting their behavior patterns based on user emotions. Specifically, the creation unit accepts as input multimodal data for user emotion estimation, such as facial image tensors (e.g., 224×224×3), audio waveform data (e.g., 16,000 dimensions), and text utterance data (e.g., 100 tokens). Examples of input include “smiling face image” and “text saying ‘I'm excited about the new product.’” The creation unit processes these data using CNN or Transformer-type neural networks, and outputs emotion labels such as “excited,” “relaxed,” “stressed,” and emotion scores (e.g., excitement level 0.85, relaxation level 0.10, stress level 0.05) in an emotion classification layer. Examples of output include “Emotion label: excited, score 0.92” and “Emotion label: relaxed, score 0.75.” Based on the emotion estimation results, the creation unit assigns behavior pattern parameters (e.g., activeness score, cooperativeness score, composure score) as latent feature vectors to the generative AI's generation conditions, and generates pseudo personas with behavior patterns corresponding to emotional states using generative models such as VAE or diffusion models. For example, when the excitement level is high, the activeness score is set to 0.9; when the relaxation level is high, the cooperativeness score is set to 0.8; and when the stress level is high, the composure score is set to 0.95. Examples of output include “Pseudo Persona A: activeness 0.9, cooperativeness 0.6, composure 0.2” and “Pseudo Persona B: activeness 0.3, cooperativeness 0.8, composure 0.9.” These processes enable dynamic and automatic adjustment of behavior patterns according to user state, which differs from conventional fixed attribute setting and manual adjustment. As a technical effect, the creation unit enables real-time persona generation reflecting user psychological state, greatly improving the degree of personalization and accuracy of reaction tests and marketing measures. Application fields include consumer surveys, educational AI, patient simulation in the medical field, and interactive character generation in the entertainment field, among many others.

The test unit can estimate user emotions and adjust the scenario of reaction tests based on the estimated user emotions. For example, when the user is excited, the test unit conducts reaction tests using positive scenarios. When the user is relaxed, the test unit can conduct reaction tests using detailed scenarios. Furthermore, when the user is stressed, the test unit can conduct reaction tests using simple scenarios. As a result, the test unit can conduct more appropriate reaction tests by adjusting the scenario of reaction tests based on user emotions. Specifically, the test unit accepts as input multimodal data for user emotion estimation, such as facial image tensors (e.g., 224×224×3), audio waveform data (e.g., 16,000 dimensions), and text utterance data (e.g., 100 tokens). Examples of input include “smiling face image” and “text saying ‘I'm excited about the new product.’” The test unit processes these data using CNN or Transformer-type neural networks, and outputs emotion labels such as “excited,” “relaxed,” “stressed,” and emotion scores (e.g., excitement level 0.85, relaxation level 0.10, stress level 0.05) in an emotion classification layer. Examples of output include “Emotion label: excited, score 0.92” and “Emotion label: relaxed, score 0.75.” Based on the emotion estimation results, the test unit dynamically adjusts the content of test scenarios (e.g., number of questions, question content, scenario branching, required time) in a scenario generation module, prioritizing positive scenarios and simple questions when the excitement level is high, presenting detailed scenarios and multivariate questions when the relaxation level is high, and presenting only simple scenarios and multiple-choice questions when the stress level is high. The test unit passes the test results to subsequent reaction data collection and analysis units based on the output results of the generative AI (e.g., test scenario list, question content, branching conditions, etc.). These processes enable dynamic and automatic optimization of test scenarios according to user state, which differs from conventional fixed test design and manual scenario adjustment. As a technical effect, the test unit can automate optimal test design according to user psychological state and concentration, greatly improving the reliability and efficiency of reaction data collection. Application fields include consumer surveys, adaptive testing in educational AI, patient reaction evaluation in the medical field, and interactive experience design in the entertainment field, among many others.

The analysis unit can estimate user emotions and adjust the reporting method of test results based on the estimated user emotions. For example, if the user is excited, a positive report is provided. If the user is relaxed, a detailed report can be generated. Furthermore, if the user is feeling stressed, a simple report can be generated. In this way, the analysis unit can provide more appropriate reports by adjusting the reporting method of test results based on user emotions. Specifically, the analysis unit receives multimodal data as input for estimating user emotions, such as facial image tensors (e.g., 224×224×3), audio waveform data (e.g., 16,000 dimensions), and text utterance data (e.g., 100 tokens). Examples of input include “smiling facial images” and text such as “I am excited about the new product.” The analysis unit processes these data using CNNs or Transformer-type neural networks, and the emotion classification layer outputs emotion labels such as “excited,” “relaxed,” or “stressed,” as well as emotion scores (e.g., excitement level 0.85, relaxation level 0.10, stress level 0.05). Examples of output include “emotion label: excited, score 0.92” and “emotion label: relaxed, score 0.75.” Based on the emotion estimation results, the analysis unit dynamically adjusts the report content (e.g., summary report, detailed report, positive emphasis report) and report granularity (e.g., aggregation unit, number of variables, visualization method) in the report generation module. When the excitement level is high, a report emphasizing positive elements is generated; when the relaxation level is high, a report including detailed analysis results is generated; and when the stress level is high, a simple summary report is generated. The analysis unit utilizes the output results of the generative AI (e.g., report PDF, dashboard display data) for subsequent decision support and user feedback. These processes enable dynamic and automatic optimization of reporting methods according to user status, which is different from conventional fixed report generation or manual content adjustment. As a technical effect, the analysis unit can automate optimal report design according to the user's psychological state and concentration, thereby greatly improving the acceptability and utilization efficiency of the report content. Application fields include consumer survey analysis, academic performance reporting in educational AI, patient evaluation reporting in the medical field, and user experience reporting in the entertainment field, among many others.

The analysis unit can estimate user emotions and adjust the content of marketing strategy proposals based on the estimated user emotions. For example, if the user is excited, an aggressive marketing strategy is proposed. If the user is relaxed, a detailed marketing strategy can be proposed. Furthermore, if the user is feeling stressed, a simple marketing strategy can be proposed. In this way, the analysis unit can provide more appropriate proposals by adjusting the content of marketing strategy proposals based on user emotions. Specifically, the analysis unit receives multimodal data as input for estimating user emotions, such as facial image tensors (e.g., 224×224×3), audio waveform data (e.g., 16,000 dimensions), and text utterance data (e.g., 100 tokens). Examples of input include “smiling facial images” and text such as “I am excited about the new product.” The analysis unit processes these data using CNNs or Transformer-type neural networks, and the emotion classification layer outputs emotion labels such as “excited,” “relaxed,” or “stressed,” as well as emotion scores (e.g., excitement level 0.85, relaxation level 0.10, stress level 0.05). Examples of output include “emotion label: excited, score 0.92” and “emotion label: relaxed, score 0.75.” Based on the emotion estimation results, the analysis unit dynamically adjusts the proposal content (e.g., aggressive strategy, detailed strategy, simple strategy) and proposal granularity (e.g., number of measures, content of measures, execution priority) in the strategy proposal generation module. When the excitement level is high, aggressive strategies such as launching new products or large-scale promotions are proposed; when the relaxation level is high, detailed targeting or multi-stage measures are proposed; and when the stress level is high, simple measures or phased introduction are proposed. The analysis unit utilizes the output results of the generative AI (e.g., strategy proposal list, content of measures, priorities) to provide information for subsequent decision support and execution departments. These processes enable dynamic and automatic optimization of strategy proposals according to user status, which is different from conventional fixed strategy proposals or manual content adjustment. As a technical effect, the analysis unit can automate optimal strategy proposals according to the user's psychological state and concentration, thereby greatly improving the acceptability and execution efficiency of the proposal content. Application fields include consumer survey analysis, advertising strategy planning, product development measures, learning strategy proposals in educational AI, and treatment policy proposals in the medical field, among many others.

Below, the processing flow of Example of the Embodiment is briefly described. Specifically, the present system realizes pipeline processing by linking multiple AI modules (learning unit, creation unit, test unit, analysis unit). Each unit clearly defines the type, format, and dimensionality of input data, and dynamically optimizes the architecture and parameters of AI models while automatically controlling the overall data flow. For example, the learning unit extracts features from market data (e.g., purchase history tensors, competitor trend time series, economic indicator arrays) using LSTM or Transformer-type neural networks and generates feature vectors of individuals. The creation unit inputs the output feature vectors from the learning unit into generative models such as VAEs or diffusion models to generate diverse pseudo personas reflecting target customer profiles and behavioral patterns. The test unit uses the pseudo personas generated by the creation unit to conduct various reaction tests such as A/B tests, scenario-based questionnaires, and VR tests, and collects reaction data (e.g., purchase intention scores, comments, behavioral logs). The analysis unit processes the reaction data obtained from the test unit using multivariate analysis models such as clustering, regression analysis, and trend extraction, and outputs decision support information (e.g., reaction distribution by target segment, price optimization proposals, advertising channel recommendations). Each unit dynamically adjusts AI model hyperparameters (e.g., learning rate, batch size, loss function weights) and data sampling ratios to promptly respond to user emotion estimation and market trend changes. Furthermore, by combining extension modules such as feedback collection units, real-time data collection functions, multilingual support functions, VR test functions, and predictive analysis functions, the overall system accuracy, adaptability, and operational efficiency can be greatly improved. These processes, unlike conventional static design or single-model operation by manual means, realize the advancement of computer technology itself through the linkage of multiple AI models, dynamic control, and high-dimensional data analysis. As a technical effect, the present system can greatly improve responsiveness to market changes, model accuracy, data processing efficiency, and the quality of user experience. Application fields include consumer surveys, advertising optimization, financial risk assessment, medical diagnostic support, educational AI, and interactive experience design in the entertainment field, among many others.

Step 1: The learning unit learns data related to a market. Data related to a market includes consumer purchase history, competitor trends, and economic indicators. The learning unit learns market data using algorithms such as machine learning and deep learning, and learns features of individuals existing in the market based on large amounts of market data. Step 2: The creation unit creates a pseudo persona based on features learned by the learning unit. The pseudo persona is created based on target customer profiles and behavioral patterns, and a generative AI is used to create a pseudo persona with features very similar to those of individuals actually existing in the market. Step 3: The test unit conducts reaction tests using the pseudo persona created by the creation unit. Reaction tests include questionnaire surveys and A/B tests, and a generative AI is used to observe the reactions of the pseudo persona and collect data. Step 4: The analysis unit analyzes test results obtained by the test unit. The analysis includes statistical analysis and data mining, and a generative AI is used to provide information for formulating marketing strategies based on the test results. Specifically, in Step 1, the learning unit extracts time-series features from consumer purchase history tensors (e.g., purchase counts for 10,000 people over 12 months), competitor trend time-series data (e.g., sales and price transitions for 50 products over 24 months), and economic indicator arrays (e.g., GDP growth rate, unemployment rate for 12 months) using LSTM or Transformer-type neural networks, and generates feature vectors of individuals (e.g., 100-dimensional vectors for age, gender, purchase tendency, price sensitivity, etc.). In Step 2, the creation unit inputs the output feature vectors from the learning unit into generative models such as VAEs or diffusion models to generate diverse pseudo personas reflecting target customer profiles and behavioral patterns (e.g., new product orientation 0.8, price sensitivity 0.7, health orientation 0.6, etc.). In Step 3, the test unit uses the pseudo personas generated by the creation unit to conduct various reaction tests such as A/B tests, scenario-based questionnaires, and VR tests, and collects reaction data (e.g., purchase intention scores, comments, behavioral logs). The test unit dynamically adjusts test questions and scenarios according to user emotion estimation and market segment characteristics to enhance the reliability and diversity of reaction data. In Step 4, the analysis unit processes the reaction data obtained from the test unit using multivariate analysis models such as clustering, regression analysis, and trend extraction, and outputs decision support information (e.g., reaction distribution by target segment, price optimization proposals, advertising channel recommendations). The analysis unit dynamically optimizes analysis methods and report content according to user emotion estimation and market trend changes, thereby improving the accuracy and responsiveness of marketing strategy formulation. Furthermore, by combining extension modules such as feedback collection units, real-time data collection functions, multilingual support functions, VR test functions, and predictive analysis functions, the overall system accuracy, adaptability, and operational efficiency can be greatly improved. These processes, unlike conventional static design or single-model operation by manual means, realize the advancement of computer technology itself through the linkage of multiple AI models, dynamic control, and high-dimensional data analysis. As a technical effect, the present system can greatly improve responsiveness to market changes, model accuracy, data processing efficiency, and the quality of user experience. Application fields include consumer surveys, advertising optimization, financial risk assessment, medical diagnostic support, educational AI, and interactive experience design in the entertainment field, among many others.

The specific processing unit 290 sends the results of specific processing to the smart device 14. In the smart device 14, the control unit 46A causes the output device 40 to output the results of specific processing. The microphone 38B acquires voice indicating user input in response to the results of specific processing. The control unit 46A sends the voice data indicating user input acquired by the microphone 38B to the data processing device 12. In the data processing device 12, the specific processing unit 290 acquires the voice data.

The data generation model 58 is a so-called generative AI (Artificial Intelligence). An example of the data generation model 58 is a generative AI such as ChatGPT (registered trademark) (Internet search<URL: https://openai.com/blog/chatgpt>). The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

Moreover, the processing by the data processing system 10 described above is executed by the specific processing unit 290 of the data processing device 12 or the control unit 46A of the smart device 14, but it may be executed by both the specific processing unit 290 of the data processing device 12 and the control unit 46A of the smart device 14. Additionally, the specific processing unit 290 of the data processing device 12 acquires or collects necessary information for processing from the smart device 14 or external devices, and the smart device 14 acquires or collects necessary information for processing from the data processing device 12 or external devices.

Each of the plurality of elements including the aforementioned learning unit, creation unit, test unit, and analysis unit is implemented, for example, by at least one of a smart device 14 and a data processing apparatus 12. For example, the learning unit is implemented by a specific processing unit 290 of the data processing apparatus 12 and learns data related to a market. The creation unit is implemented, for example, by the specific processing unit 290 of the data processing apparatus 12 and creates a pseudo persona based on features learned by a generative AI. The test unit is implemented, for example, by a control unit 46A of the smart device 14 and conducts reaction tests using the pseudo persona. The analysis unit is implemented, for example, by the specific processing unit 290 of the data processing apparatus 12 and analyzes test results and provides information for formulating marketing strategies. The correspondence between each unit and the apparatus or control unit is not limited to the examples described above and various modifications are possible.

### Second Embodiment

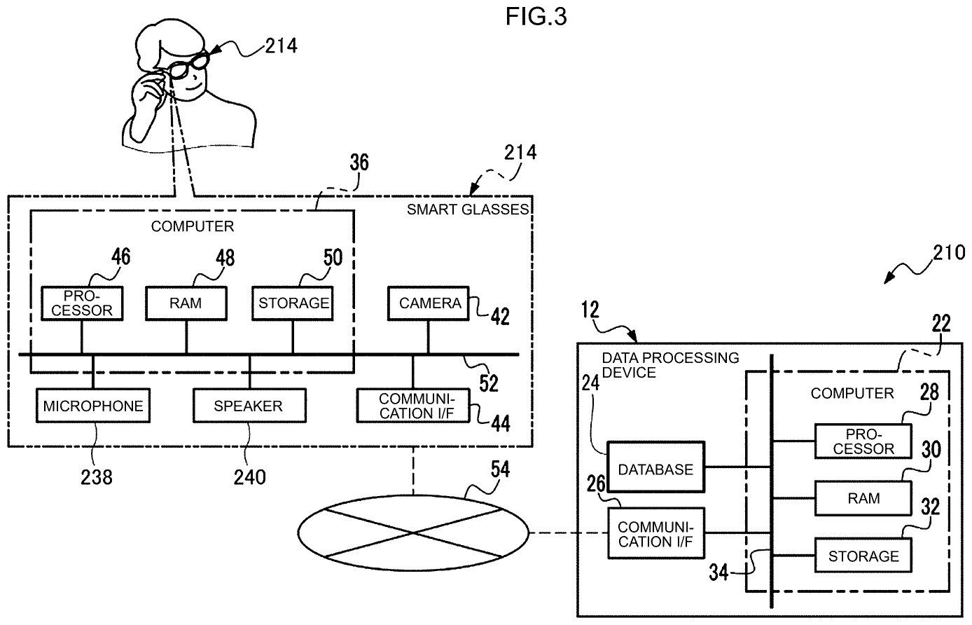

FIG. 3 shows an example configuration of a data processing system 210 according to the second embodiment.

As shown in FIG. 3, the data processing system 210 comprises a data processing device 12 and smart glasses 214. An example of the data processing device 12 is a server.

The data processing device 12 comprises a computer 22, a database 24, and a communication I/F 26. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN and/or a LAN, among others.

The smart glasses 214 comprise a computer 36, a microphone 238, a speaker 240, a camera 42, and a communication I/F 44. The computer 36 comprises a processor 46, RAM 48, and storage 50. The processor 46, RAM 48, and storage 50 are connected to a bus 52. The microphone 238, speaker 240, and camera 42 are also connected to the bus 52.

The microphone 238 accepts voice from the user, accepting instructions, among others, from the user. The microphone 238 captures the voice emitted by the user, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors, and captures the surroundings of the user (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

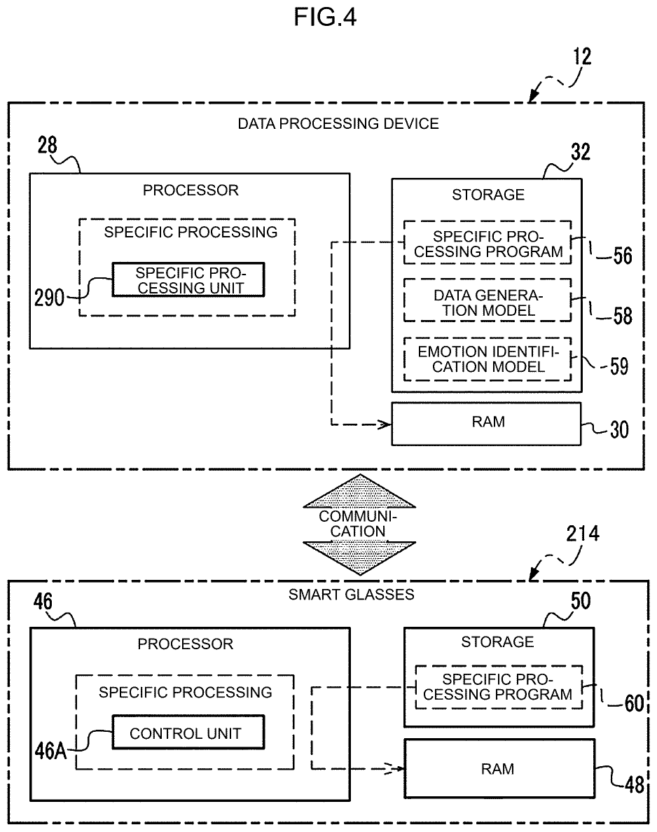

FIG. 4 shows an example of the main functions of the data processing device 12 and smart glasses 214. As shown in FIG. 4, specific processing is performed in the data processing device 12 by the processor 28. The storage 32 stores a specific processing program 56.

The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, but is not limited to such examples. Furthermore, emotion estimation and prediction may include, for example, emotion analysis.

In the smart glasses 214, specific processing is performed by the processor 46. The storage 50 stores a specific processing program 60. The processor 46 reads the specific processing program 60 from the storage 50 and executes it on the RAM 48. The specific processing is realized by the processor 46 operating as a control unit 46A according to the specific processing program 60 executed on the RAM 48. The smart glasses 214 may also have similar data generation models and emotion identification models as the data generation model 58 and emotion identification model 59, and perform the same processing as the specific processing unit 290 using these models.

Other devices besides the data processing device 12 may have the data generation model 58. For example, a server device may have the data generation model 58. In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.).

The specific processing unit 290 sends the results of specific processing to the smart glasses 214. In the smart glasses 214, the control unit 46A causes the speaker 240 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

The data generation model 58 is a so-called generative AI. An example of the data generation model 58 is a generative AI such as ChatGPT. The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

The data processing system 210 according to the second embodiment performs the same processing as the data processing system 10 according to the first embodiment. The processing by the data processing system 210 is executed by the specific processing unit 290 of the data processing device 12 or the control unit 46A of the smart glasses 214, but it may be executed by both the specific processing unit 290 of the data processing device 12 and the control unit 46A of the smart glasses 214. Additionally, the specific processing unit 290 of the data processing device 12 acquires or collects necessary information for processing from the smart glasses 214 or external devices, and the smart glasses 214 acquires or collects necessary information for processing from the data processing device 12 or external devices.

Each of the plurality of elements including the aforementioned learning unit, creation unit, test unit, and analysis unit is implemented, for example, by at least one of smart glasses 214 and a data processing apparatus 12. For example, the learning unit is implemented by a specific processing unit 290 of the data processing apparatus 12 and learns data related to a market. The creation unit is implemented, for example, by the specific processing unit 290 of the data processing apparatus 12 and creates a pseudo persona based on features learned by a generative AI. The test unit is implemented, for example, by a control unit 46A of the smart glasses 214 and conducts reaction tests using the pseudo persona. The analysis unit is implemented, for example, by the specific processing unit 290 of the data processing apparatus 12 and analyzes test results and provides information for formulating marketing strategies. The correspondence between each unit and the apparatus or control unit is not limited to the examples described above and various modifications are possible.

### Third Embodiment

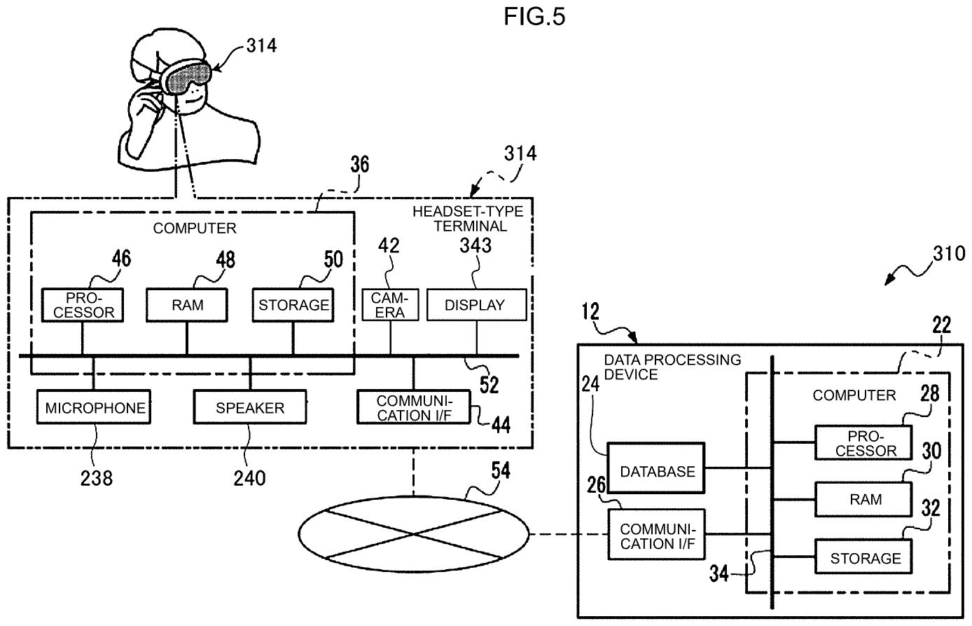

FIG. 5 shows an example configuration of a data processing system 310 according to the third embodiment.

As shown in FIG. 5, the data processing system 310 comprises a data processing device 12 and a headset-type terminal 314. An example of the data processing device 12 is a server.

The data processing device 12 comprises a computer 22, a database 24, and a communication I/F 26. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN and/or a LAN, among others.

The headset-type terminal 314 comprises a computer 36, a microphone 238, a speaker 240, a camera 42, a communication I/F 44, and a display 343. The computer 36 comprises a processor 46, RAM 48, and storage 50. The processor 46, RAM 48, and storage 50 are connected to a bus 52. The microphone 238, speaker 240, camera 42, and display 343 are also connected to the bus 52.

The microphone 238 accepts voice from the user, accepting instructions, among others, from the user. The microphone 238 captures the voice emitted by the user, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors, and captures the surroundings of the user (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

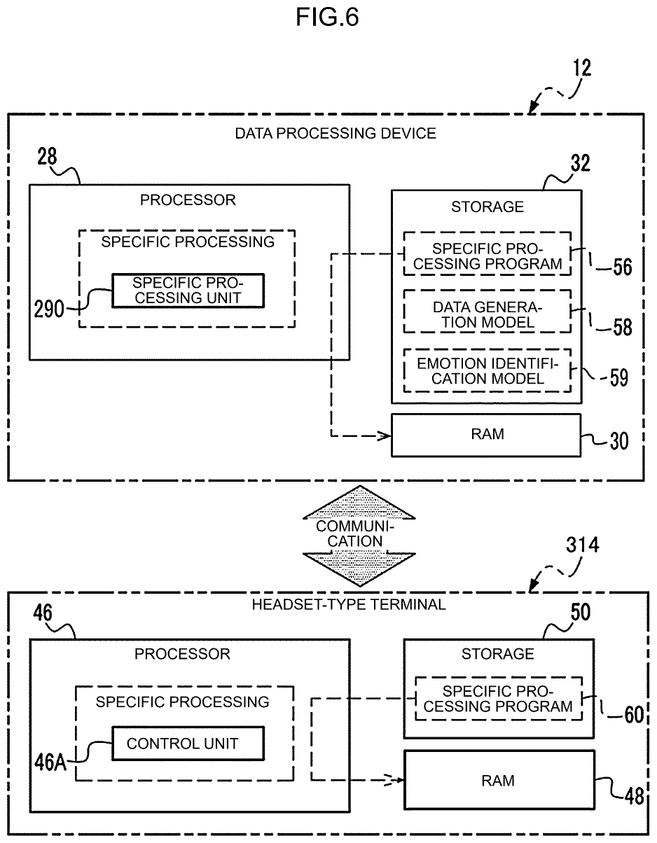

FIG. 6 shows an example of the main functions of the data processing device 12 and the headset-type terminal 314. As shown in FIG. 6, specific processing is performed in the data processing device 12 by the processor 28. The storage 32 stores a specific processing program 56.

The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, but is not limited to such examples. Furthermore, emotion estimation and prediction may include, for example, emotion analysis.

In the headset-type terminal 314, specific processing is performed by the processor 46. The storage 50 stores a specific program 60. The processor 46 reads the specific program 60 from the storage 50 and executes it on the RAM 48. The specific processing is realized by the processor 46 operating as a control unit 46A according to the specific program 60 executed on the RAM 48. The headset-type terminal 314 may also have similar data generation models and emotion identification models as the data generation model 58 and emotion identification model 59, and perform the same processing as the specific processing unit 290 using these models.

Other devices besides the data processing device 12 may have the data generation model 58. For example, a server device may have the data generation model 58. In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.).

The specific processing unit 290 sends the results of specific processing to the headset-type terminal 314. In the headset-type terminal 314, the control unit 46A causes the speaker 240 and the display 343 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

The data generation model 58 is a so-called generative AI. An example of the data generation model 58 is a generative AI such as ChatGPT. The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

The data processing system 310 according to the third embodiment performs the same processing as the data processing system 10 according to the first embodiment. The processing by the data processing system 310 is executed by the specific processing unit 290 of the data processing device 12 or the control unit 46A of the headset-type terminal 314, but it may be executed by both the specific processing unit 290 of the data processing device 12 and the control unit 46A of the headset-type terminal 314. Additionally, the specific processing unit 290 of the data processing device 12 acquires or collects necessary information for processing from the headset-type terminal 314 or external devices, and the headset-type terminal 314 acquires or collects necessary information for processing from the data processing device 12 or external devices.

Each of the plurality of elements including the aforementioned learning unit, creation unit, test unit, and analysis unit is implemented, for example, by at least one of a headset-type terminal 314 and a data processing apparatus 12. For example, the learning unit is implemented by a specific processing unit 290 of the data processing apparatus 12 and learns data related to a market. The creation unit is implemented, for example, by the specific processing unit 290 of the data processing apparatus 12 and creates a pseudo persona based on features learned by a generative AI. The test unit is implemented, for example, by a control unit 46A of the headset-type terminal 314 and conducts reaction tests using the pseudo persona. The analysis unit is implemented, for example, by the specific processing unit 290 of the data processing apparatus 12 and analyzes test results and provides information for formulating marketing strategies. The correspondence between each unit and the apparatus or control unit is not limited to the examples described above and various modifications are possible.

### Fourth Embodiment

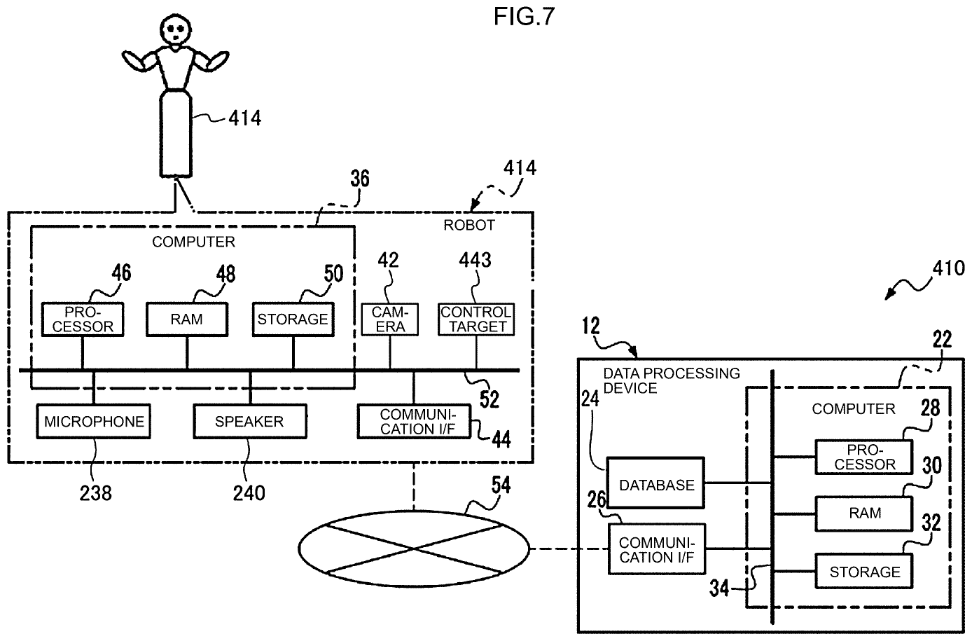

FIG. 7 shows an example configuration of a data processing system 410 according to the fourth embodiment.

As shown in FIG. 7, the data processing system 410 comprises a data processing device 12 and a robot 414. An example of the data processing device 12 is a server.

The data processing device 12 comprises a computer 22, a database 24, and a communication I/F 26. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN and/or a LAN, among others.

The robot 414 comprises a computer 36, a microphone 238, a speaker 240, a camera 42, a communication I/F 44, and a control target 443. The computer 36 comprises a processor 46, RAM 48, and storage 50. The processor 46, RAM 48, and storage 50 are connected to a bus 52. The microphone 238, speaker 240, camera 42, and control target 443 are also connected to the bus 52.

The microphone 238 accepts voice from the user, accepting instructions, among others, from the user. The microphone 238 captures the voice emitted by the user, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS image sensors or CCD image sensors, and captures the surroundings of the user (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

The control target 443 includes a display device, LEDs for the eyes, and motors for driving arms, hands, and feet, among others. The posture and gestures of the robot 414 are controlled by controlling the motors for the arms, hands, and feet, among others. Some emotions of the robot 414 can be expressed by controlling these motors. Additionally, the expression of the robot 414 can be expressed by controlling the lighting state of the LEDs for the eyes of the robot 414.

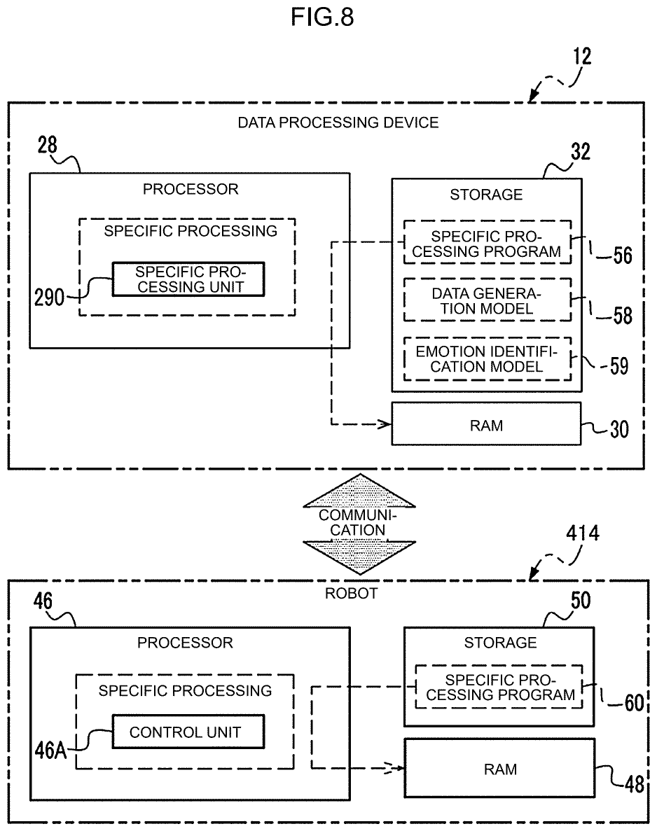

FIG. 8 shows an example of the main functions of the data processing device 12 and the robot 414. As shown in FIG. 8, specific processing is performed in the data processing device 12 by the processor 28. The storage 32 stores a specific processing program 56.

The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, but is not limited to such examples. Furthermore, emotion estimation and prediction may include, for example, emotion analysis.

In the robot 414, specific processing is performed by the processor 46. The storage 50 stores a specific program 60. The processor 46 reads the specific program 60 from the storage 50 and executes it on the RAM 48. The specific processing is realized by the processor 46 operating as a control unit 46A according to the specific program 60 executed on the RAM 48. The robot 414 may also have similar data generation models and emotion identification models as the data generation model 58 and emotion identification model 59, and perform the same processing as the specific processing unit 290 using these models.

Other devices besides the data processing device 12 may have the data generation model 58. For example, a server device may have the data generation model 58. In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.).

The specific processing unit 290 sends the results of specific processing to the robot 414. In the robot 414, the control unit 46A causes the speaker 240 and the control target 443 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

The data generation model 58 is a so-called generative AI. An example of the data generation model 58 is a generative AI such as ChatGPT. The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

The data processing system 410 according to the fourth embodiment performs the same processing as the data processing system 10 according to the first embodiment. The processing by the data processing system 410 is executed by the specific processing unit 290 of the data processing device 12 or the control unit 46A of the robot 414, but it may be executed by both the specific processing unit 290 of the data processing device 12 and the control unit 46A of the robot 414. Additionally, the specific processing unit 290 of the data processing device 12 acquires or collects necessary information for processing from the robot 414 or external devices, and the robot 414 acquires or collects necessary information for processing from the data processing device 12 or external devices.

Each of the plurality of elements including the aforementioned learning unit, creation unit, test unit, and analysis unit is implemented, for example, by at least one of a robot 414 and a data processing apparatus 12. For example, the learning unit is implemented by a specific processing unit 290 of the data processing apparatus 12 and learns data related to a market. The creation unit is implemented, for example, by the specific processing unit 290 of the data processing apparatus 12 and creates a pseudo persona based on features learned by a generative AI. The test unit is implemented, for example, by a control unit 46A of the robot 414 and conducts reaction tests using the pseudo persona. The analysis unit is implemented, for example, by the specific processing unit 290 of the data processing apparatus 12 and analyzes test results and provides information for formulating marketing strategies. The correspondence between each unit and the apparatus or control unit is not limited to the examples described above and various modifications are possible.

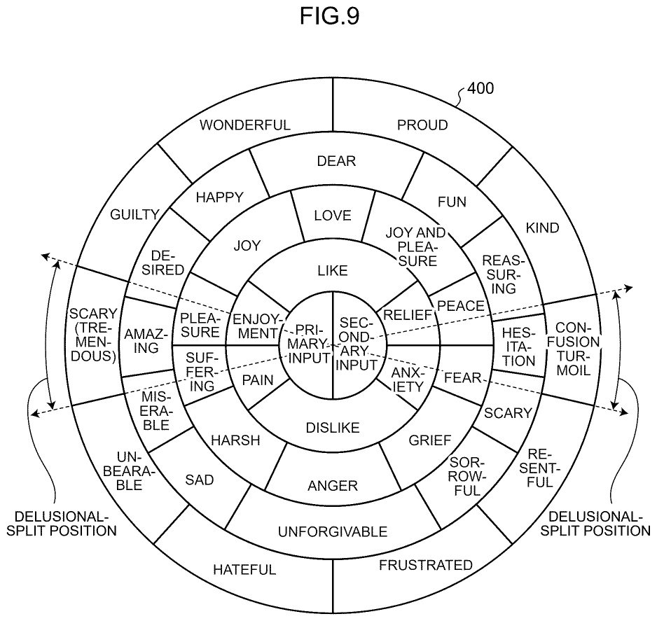

Note that the emotion identification model 59 as an emotion engine may determine the user's emotions according to a specific mapping. Specifically, the emotion identification model 59 may determine the user's emotions according to an emotion map, which is a specific mapping (see FIG. 9). Similarly, the emotion identification model 59 may determine the robot's emotions, and the specific processing unit 290 may perform specific processing using the robot's emotions.

FIG. 9 is a diagram showing an emotion map 400 where multiple emotions are mapped. In the emotion map 400, emotions are arranged concentrically radiating from the center. The closer to the center of the concentric circles, the more primitive the state of emotions is arranged. On the outer side of the concentric circles, emotions representing states and behaviors arising from mood are arranged. Emotions encompass concepts including emotional and mental states. On the left side of the concentric circles, emotions generally generated from reactions occurring in the brain are arranged. On the right side of the concentric circles, emotions generally induced by situational judgment are arranged. On the top and bottom of the concentric circles, emotions generated from reactions occurring in the brain and induced by situational judgment are arranged. Additionally, on the upper side of the concentric circles, “pleasant” emotions are arranged, and on the lower side, “unpleasant” emotions are arranged. In this way, in the emotion map 400, multiple emotions are mapped based on the structure from which emotions arise, and emotions that tend to occur simultaneously are mapped nearby.

These emotions are distributed in the 3 o'clock direction of the emotion map 400, and they usually move back and forth around reassurance and anxiety. In the right half of the emotion map 400, situational recognition takes precedence over internal sensations, giving a calm impression.

The inner side of the emotion map 400 represents the mind, and the outer side represents behavior, so the further out on the emotion map 400, the more visible (expressed in behavior) emotions become.

Here, human emotions are based on various balances like posture and blood sugar levels, and when these balances move away from the ideal, they indicate discomfort, and when they approach the ideal, they indicate comfort. In robots, cars, motorcycles, etc., emotions can be created based on various balances like posture and battery level, indicating discomfort when these balances move away from the ideal and comfort when they approach the ideal. The emotion map may be generated based on Dr. Mitsuyoshi's emotion map (Research on speech emotion recognition and brain physiological signal analysis systems related to emotions, Tokushima University, Doctoral dissertation: https://ci.nii.ac.jp/naid/500000375379). In the left half of the emotion map, emotions belonging to the domain called “reactions,” where sensations take precedence, are aligned. Additionally, in the right half of the emotion map, emotions belonging to the domain called “situations,” where situational recognition takes precedence, are aligned.

In the emotion map, two emotions that promote learning are defined. One is a negative emotion around “repentance” or “reflection” on the situation side. In other words, when a negative emotion arises in the robot, like “I never want to feel this way again” or “I don't want to be scolded again.” The other is an emotion around “desire” on the reaction side, which is positive. In other words, it is a positive feeling like “I want more” or “I want to know more.”

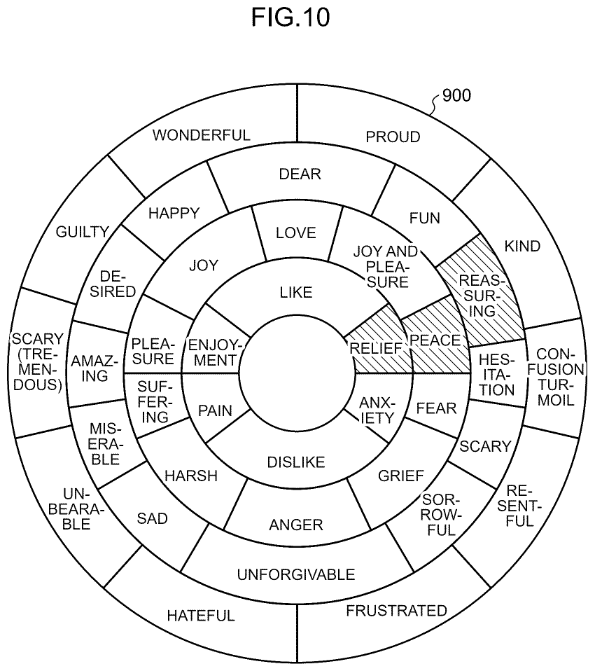

The emotion identification model 59 inputs user input into a pre-learned neural network, acquires emotion values indicating each emotion shown in the emotion map 400, and determines the user's emotions. This neural network is pre-learned based on multiple training data consisting of user input and combinations of emotion values indicating each emotion shown in the emotion map 400. Additionally, this neural network is learned so that emotions placed near each other in the emotion map 900 shown in FIG. 10 have similar values. FIG. 10 shows an example where multiple emotions like “reassured,” “calm,” and “confident” have similar emotion values.

In the above embodiments, an example form where specific processing is performed by a single computer 22 was described, but the technology disclosed herein is not limited to this, and distributed processing for specific processing by multiple computers including the computer 22 may be performed.

In the above embodiments, an example form where the specific processing program 56 is stored in the storage 32 was described, but the technology disclosed herein is not limited to this. For example, the specific processing program 56 may be stored in portable non-transitory storage media readable by a computer, such as a USB (Universal Serial Bus) memory. The specific processing program 56 stored in non-transitory storage media is installed in the computer 22 of the data processing device 12. The processor 28 executes specific processing according to the specific processing program 56.

Additionally, the specific processing program 56 may be stored in a storage device, such as a server connected to the data processing device 12 via the network 54, and downloaded and installed on the computer 22 in response to requests from the data processing device 12.

Furthermore, it is not necessary to store all of the specific processing program 56 in storage devices such as servers connected to the data processing device 12 via the network 54 or all in the storage 32, and a part of the specific processing program 56 may be stored.

Various processors, as shown next, can be used as hardware resources for executing specific processing. As processors, general-purpose processors that function as hardware resources for executing specific processing by executing software, i.e., programs, such as a CPU, can be mentioned. Additionally, as processors, dedicated electrical circuits with circuit configurations specially designed to execute specific processing, such as FPGA (Field-Programmable Gate Array), PLD (Programmable Logic Device), or ASIC (Application Specific Integrated Circuit), can be mentioned. Each processor has a built-in or connected memory, and each processor executes specific processing using the memory.

Hardware resources for executing specific processing may be composed of one of these various processors or a combination of two or more processors of the same or different types (e.g., a combination of multiple FPGAs or a combination of a CPU and FPGA). Additionally, hardware resources for executing specific processing may be a single processor.

As an example of composing with a single processor, firstly, there is a form where one or more CPUs and software are combined to constitute a single processor, which functions as hardware resources for executing specific processing. Secondly, there is a form using a processor, such as SoC (System-on-a-chip), that realizes the function of an entire system including multiple hardware resources for executing specific processing with a single IC chip. In this way, specific processing is realized using one or more of the various processors as hardware resources.

Furthermore, as a hardware structure of these various processors, more specifically, electrical circuits combined with circuit elements such as semiconductor elements can be used. Additionally, the specific processing described above is merely one example. Therefore, it goes without saying that unnecessary steps may be deleted, new steps may be added, or the order of processing may be changed within the scope not departing from the gist.

Additionally, in the examples described above, the explanation was divided into the first embodiment to the fourth embodiment, but parts or all of these embodiments may be combined. Additionally, the smart device 14, smart glasses 214, headset-type terminal 314, and robot 414 are examples, and each may be combined, or other devices may be used.

The descriptions and drawings shown above are detailed explanations of parts related to the technology disclosed herein and are merely examples of the technology disclosed herein. For example, the explanations regarding configurations, functions, actions, and effects above are explanations regarding examples of configurations, functions, actions, and effects of parts related to the technology disclosed herein. Therefore, it goes without saying that within the scope not departing from the gist of the technology disclosed herein, unnecessary parts may be deleted, new elements may be added, or replacements may be made to the descriptions and drawings shown above. Additionally, to avoid complexity and facilitate understanding of parts related to the technology disclosed herein, explanations concerning technical common knowledge and the like that do not require special explanation for enabling the implementation of the technology disclosed herein are omitted in the descriptions and drawings shown above.

All documents, patent applications, and technical standards described in this specification are incorporated by reference to the same extent as if each document, patent application, and technical standard were specifically and individually stated to be incorporated by reference in this specification.

(Supplementary Note 1) A system comprising: a learning unit configured to learn data related to a market; a creation unit configured to create a pseudo persona based on features learned by the learning unit; a test unit configured to conduct reaction tests using the pseudo persona created by the creation unit; and an analysis unit configured to analyze test results obtained by the test unit.

(Supplementary Note 2) The system according to Supplementary Note 1, wherein the learning unit is configured to input data related to the market and a generative AI learns features of individuals existing in the market based on the data.

(Supplementary Note 3) The system according to Supplementary Note 1, wherein the creation unit is configured to create a pseudo persona based on features learned by the generative AI.

(Supplementary Note 4) The system according to Supplementary Note 1, wherein the test unit is configured to conduct reaction tests using the pseudo persona.

(Supplementary Note 5) The system according to Supplementary Note 1, wherein the analysis unit is configured to analyze test results and provide information for formulating marketing strategies.

(Supplementary Note 6) A system wherein the learning unit is configured to estimate user emotions and adjust the timing of learning market data based on the estimated user emotions.

(Supplementary Note 7) A system wherein the learning unit is configured to adjust a learning algorithm by referring to past market trends during learning of market data.

(Supplementary Note 8) The system according to Supplementary Note 1, wherein the learning unit is configured to focus on a specific market segment during learning of market data.

(Supplementary Note 9) A system wherein the learning unit is configured to estimate user emotions and determine the priority of learning data based on the estimated user emotions.

(Supplementary Note 10) The system according to Supplementary Note 1, wherein the learning unit is configured to consider geographical market characteristics during learning of market data.

(Supplementary Note 11) The system according to Supplementary Note 1, wherein the learning unit is configured to analyze social media trends and reflect them in learning during learning of market data.

(Supplementary Note 12) A system wherein the creation unit is configured to estimate user emotions and adjust features of the pseudo persona based on the estimated user emotions.

(Supplementary Note 13) A system wherein the creation unit is configured to adjust features by referring to past market data during creation of the pseudo persona.

(Supplementary Note 14) The system according to Supplementary Note 1, wherein the creation unit is configured to set features by focusing on a specific market segment during creation of the pseudo persona.

(Supplementary Note 15) A system wherein the creation unit is configured to estimate user emotions and determine the priority of the pseudo persona based on the estimated user emotions.

(Supplementary Note 16) The system according to Supplementary Note 1, wherein the creation unit is configured to set features by considering geographical market characteristics during creation of the pseudo persona.

(Supplementary Note 17) The system according to Supplementary Note 1, wherein the creation unit is configured to analyze social media trends and reflect them in features during creation of the pseudo persona.

(Supplementary Note 18) A system wherein the test unit is configured to estimate user emotions and adjust methods of reaction tests based on the estimated user emotions.

(Supplementary Note 19) A system wherein the test unit is configured to adjust a test algorithm by referring to past test data during reaction tests.

(Supplementary Note 20) The system according to Supplementary Note 1, wherein the test unit is configured to conduct tests by focusing on a specific market segment during reaction tests.

(Supplementary Note 21) A system wherein the test unit is configured to estimate user emotions and determine the priority of reaction tests based on the estimated user emotions.

(Supplementary Note 22) The system according to Supplementary Note 1, wherein the test unit is configured to conduct tests by considering geographical market characteristics during reaction tests.

(Supplementary Note 23) The system according to Supplementary Note 1, wherein the test unit is configured to analyze social media trends and reflect them in tests during reaction tests.

(Supplementary Note 24) A system wherein the analysis unit is configured to estimate user emotions and adjust methods of analyzing test results based on the estimated user emotions.

(Supplementary Note 25) A system wherein the analysis unit is configured to adjust an analysis algorithm by referring to past analysis data during analysis of test results.

(Supplementary Note 26) The system according to Supplementary Note 1, wherein the analysis unit is configured to conduct analysis by focusing on a specific market segment during analysis of test results.

(Supplementary Note 27) A system wherein the analysis unit is configured to estimate user emotions and determine the priority of test results based on the estimated user emotions.

(Supplementary Note 28) The system according to Supplementary Note 1, wherein the analysis unit is configured to conduct analysis by considering geographical market characteristics during analysis of test results.

(Supplementary Note 29) The system according to Supplementary Note 1, wherein the analysis unit is configured to analyze social media trends and reflect them in results during analysis of test results.

What is claimed is:

1. A system comprising:
circuitry configured to:
extract a feature representation from structured input data by processing the structured input data through a Transformer-based neural network to generate a multidimensional feature tensor;
generate a synthetic attribute vector based on the multidimensional feature tensor by inputting the multidimensional feature tensor into a variational autoencoder to produce the synthetic attribute vector approximating latent characteristics encoded in the structured input data;
execute an inference operation on the synthetic attribute vector by inputting the synthetic attribute vector together with target data into a data generation model to produce inference data indicating a predicted response; and
generate decision-support data by applying at least one of clustering, principal component analysis, or regression analysis to the inference data.

2. The system according to claim 1, wherein the structured input data comprises at least one of consumer attribute vectors, competitor trend tensors, or economic indicator arrays.

3. The system according to claim 1, wherein the circuitry is further configured to normalize and encode the structured input data in a feature extraction layer of the Transformer-based neural network prior to generating the multidimensional feature tensor.

4. The system according to claim 1, wherein the variational autoencoder performs latent space sampling to produce the synthetic attribute vector, and wherein the circuitry is further configured to apply conditional generation to tailor the synthetic attribute vector to a specified target group.

5. The system according to claim 1, wherein the data generation model comprises a large language model or a multimodal generative model, and the inference data comprises at least one of a predicted score or a generated natural-language comment.

6. The system according to claim 1, wherein the circuitry is further configured to update weights of the Transformer-based neural network using at least one of gradient descent or Adam optimization with a loss function comprising at least one of cross-entropy or mean squared error.

7. The system according to claim 1, wherein the circuitry is further configured to apply at least one of data augmentation or transfer learning during training of the variational autoencoder to enhance generalization performance of the synthetic attribute vector generation.

8. The system according to claim 1, wherein the circuitry is further configured to extract time-series features from historical trend data using at least one of a long short-term memory network or a Transformer-based neural network, and to adjust hyperparameters of the feature extraction based on the extracted time-series features.

9. The system according to claim 8, wherein the hyperparameters comprise at least one of a learning rate, a batch size, a weight initialization method, or a regularization coefficient, and the circuitry adjusts the hyperparameters based on seasonal variation components or event impact features detected in the historical trend data.

10. The system according to claim 1, wherein the circuitry is further configured to filter the structured input data based on a segment attribute vector specifying at least one of an age group, a region, an income class, or a preference category, and to set different loss function weights for each segment during the feature extraction.

11. The system according to claim 1, wherein the circuitry is further configured to extract geographic attribute vectors from the structured input data using a geospatial clustering algorithm, and to set different data sampling ratios for each geographic region during the feature extraction.

12. The system according to claim 1, wherein the circuitry is further configured to process text embedding vectors encoded by a language model and hashtag frequency vectors through a natural language processing model to calculate trend scores, and to preferentially incorporate data associated with trend scores exceeding a threshold into the feature extraction.

13. The system according to claim 1, wherein the circuitry is further configured to estimate an emotion of a user by processing at least one of a facial image tensor, a voice waveform array, or text utterance data through an emotion identification model to produce an emotion label and an emotion score.

14. The system according to claim 13, wherein the circuitry is further configured to adjust a timing of the feature extraction based on the emotion score, such that when the emotion score indicates an excitement level exceeding a first threshold, the circuitry increases a batch size, and when the emotion score indicates a stress level exceeding a second threshold, the circuitry temporarily suspends the feature extraction.

15. The system according to claim 13, wherein the circuitry is further configured to add emotion parameters derived from the emotion score to a latent feature vector as generation conditions for the variational autoencoder, such that when the emotion score indicates excitement, the circuitry increases an activeness parameter of the synthetic attribute vector, and when the emotion score indicates stress, the circuitry increases a risk-tolerance parameter of the synthetic attribute vector.

16. The system according to claim 13, wherein the circuitry is further configured to dynamically adjust a granularity of the inference operation based on the emotion score, such that when the emotion score indicates relaxation, the circuitry executes a detailed multivariate analysis, and when the emotion score indicates stress, the circuitry executes a summary aggregation of key indicators.

17. The system according to claim 1, wherein the circuitry is further configured to execute the inference operation in parallel across a plurality of synthetic attribute vectors on a GPU-based computing cluster, and to aggregate the inference data from the plurality of synthetic attribute vectors to generate the decision-support data.

18. A system comprising:
circuitry configured to:
receive structured input data comprising consumer attribute vectors encoded as multidimensional numerical vectors, competitor trend tensors encoded as time-series matrices, and economic indicator arrays via a packet-switched network;
normalize and encode the structured input data in a feature extraction layer of a Transformer-based neural network comprising a multilayer perceptron, and extract a multidimensional feature tensor representing latent characteristics of the structured input data;
input the multidimensional feature tensor into a variational autoencoder that performs latent space sampling to generate a synthetic attribute vector approximating characteristics of entities represented in the structured input data;
input the synthetic attribute vector together with target data into a data generation model comprising a large language model to produce inference data comprising at least one of a predicted score or a generated natural-language comment indicating a predicted response to the target data;
process the inference data through at least one of clustering, principal component analysis, or regression analysis to generate decision-support data; and
transmit the decision-support data to a client terminal via the packet-switched network.

19. The system according to claim 18, wherein the circuitry is further configured to estimate an emotion of a user by processing multimodal data comprising at least one of a facial image tensor, a voice waveform array, or text utterance data through an emotion identification model, and to adjust at least one of a timing of the feature extraction, a generation condition of the variational autoencoder, or a granularity of the processing of the inference data based on an emotion score output by the emotion identification model.

20. A method performed by circuitry of a system, the method comprising:
extracting a feature representation from structured input data by processing the structured input data through a Transformer-based neural network to generate a multidimensional feature tensor;
generating a synthetic attribute vector based on the multidimensional feature tensor by inputting the multidimensional feature tensor into a variational autoencoder to produce the synthetic attribute vector approximating latent characteristics encoded in the structured input data;
executing an inference operation on the synthetic attribute vector by inputting the synthetic attribute vector together with target data into a data generation model to produce inference data indicating a predicted response; and
generating decision-support data by applying at least one of clustering, principal component analysis, or regression analysis to the inference data.
